(19) United States
(12) Patent Application Publication
(10) Pub. No.: US 2016/0179087 A1
(43) Pub. Date: Jun. 23, 2016

(54) Activity-centric contextual modes of operation for electronic devices

(71) Applicant: Joonyoung Lee, Seoul (KR)

(72) Inventor: Joonyoung Lee, Seoul (KR)

(21) Appl. No.: 14/484,299

(22) Filed: Sep. 12, 2014

(51) Int. Cl. G05B 19/418

(52) U.S. Cl. CPC G05B 19/418; G05B 2219/31001; G05B 2219/34338

(57) ABSTRACT

Based on an observation of user behaviors, users change functionalities of electronic devices whenever users shift their activities. For example, when a user is going to sleep, said user may turn off TV and lights, set alarm, and set vibration for smart phone. All said changes to the functionalities are related to a shift in user-activity to “sleep” and may require clicks, pinches, swipes or else to buttons, touch screens, and other user interface tools, which are all too complex for many users. This invention provides systems and methods to reduce the complexity in user interface practice. When this invention detects a new user-activity, it automatically applies required changes to functionalities, which are predefined as a mode of operation for the detected user-activity. Thus user interface practice and user experience of this invention is simple, intuitive and better suited for recent complexity in functionality.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

Currently typical user interface for mobile devices and computers in general is focused around apps (applications), more specifically app icons and functional buttons. User interface in simplified terms is “clicking app icons and buttons”. For example, when user wants to listen to music, user clicks an audio app and clicks some buttons to select playlist and play music. Such user interface, “clicking app icons and buttons” has been the most dominant computing practice since the introduction of Macintosh 128K in 1984 with graphical user interface and mouse.

Although many new user interface techniques have been introduced since 1984, such as a major breakthrough with touch screen and touch gesture recognition with Apple iPhone in 1996, the fundamentals of “clicking app icons and buttons” have not been changed. Now there are taps, swipes, pinches, and all, but these new interface techniques are fundamentally easier ways of “clicking app icons and buttons”. Furthermore, typical user interface for electronic devices in general includes a power switch and functional buttons. User interface in simplified terms is “clicking power switches and buttons”. Therefore, both user interface fundamentals for mobile device and electronic devices in general are similar in a way that in simplified terms they are both “clicking activation and functional buttons”.

Recent movement towards smart electronic devices is adding computing capabilities and network connectivity to almost all electronic devices, and thus extending functionalities beyond the devices themselves towards collective capabilities of all devices within the network. For example, smart phones now are often connected to home appliances, home automation systems, automotive vehicle electronics, or any other type of electronic devices connected to network. Such movement has added ever more functionalities but with more complexity with the user interface. The systems and methods to connect to and control other electronic devices differ in most cases, require more icons, switches, and buttons, thus add complexity, and degrade the value of interconnectivity and control.

Current user interface can be described as “functional” user interface. User is constantly changing the functionality of mobile device or electronic devices by “clicking activation and functional buttons” to user's needs. However, the complexity of functionality within a single electronic device or networked electronic devices all together reveals the limitation of mere “functional” user interface. Speech and/or gesture recognition is gaining technological advances plus popularity for its easy user interface, yet again to augment “clicking switches and buttons”.

Historically, more functionality has brought more complexity and usual solution has been new user interface. Now is the time for a new user interface beyond “clicking app icons and buttons” or “clicking power switches and buttons”. This invention is to reengineer systems and methods for user interface so that mobile experience or electronic device experience in general is better suited for recent complexity in functionality.

### BRIEF SUMMARY OF INVENTION

Complexity of functionality in mobile devices and modern electronic devices in general awaits a new user interface to resolve the issue. Resolving complexity issues requires simplifying and simplifying involves common denominators. This invention adopts context, more specifically user context, as the common denominator to simplify the complexity of functionality in electronic devices.

Context in definition is the surroundings, circumstances, environment, background or settings that determine, specify, or clarify the meaning of an event or other occurrence. In modern science, user context is often referred to as context awareness or location awareness. User's whereabouts has been the most common user context since the proliferation of mobile devices.

This invention defines user context with user's activity and/or user's intention to an activity. (From now onward, user's activity and/or user's intention to an activity is shortened to user's activity.) This invention identifies user's activity as the common denominator to simplify the complexity of functionality in electronic devices. Such identification assumes that changes to user's activity accompany functional changes to electronic devices. For example, when user is cooking, user may want to use smart phone hands-free, turn off all lights except dining room, and play classic music. But when user is watching TV, user may want to use vibration mode instead of ring tone, dim living room lights, and stop audio. User wants functional changes to electronic devices or different behaviors of electronic devices when user shifts activities.

In other words, complex functional changes to electronic devices are due to a single change in user's activity. Such one-to-many relationship between activity and functions of electronic devices is the key to simplification of complexity. This one-to-many relationship between activity and functions of electronic devices is defined in “mode of operation”. Each mode of operation includes functional changes of electronic devices required to changes in user's activity. Thus, each activity has respective mode of operation, which is defined in this invention as activity-centric contextual mode of operation for electronic devices.

In order to use user's activity as user context, defined as activity-centric context in this invention, the principle of 5W1H (When, Where, Who, What, Why, How) from linguistic grammar is used to gather information and get the complete story on user-activity. Thus, details for user-activity may include, but not limited to, time (When), place (Where), user group (Who), object (What), intention (Why), and other contextual information (How), which may be defined in data structure. Standardized data structure may be required to gather, save, access, and communicate user-activity as information within and amongst electronic devices.

As user-activity is defined as activity-centric context with the principle of 5W1H, respective functional changes of electronic devices are defined as mode of operation, which is called in this invention as “activity-centric contextual mode of operation”. Mode of operation may include, but not limited to, functions and settings for software as well as for hardware. For example, mode of operation for smart phone may include playlist and volume for audio app, or ring tone setting for the smart phone itself. Mode of operation for smart-home lighting control system may include dimming settings. Thus, when user shifts user-activity from “cooking” to “watching TV”, smart phone automatically sets to vibration mode and stops the audio app while smart-home lighting control system automatically dims the dining room lights, as said changes to functions and settings are predefined in the contextual mode of operation for “watching TV” user-activity.

User only needs to predefine how electronic devices need to function for each user-activity as contextual mode of operation. Then, whenever user engages to a predefined new user-activity, the electronic devices will change to predefined functions and settings. Therefore, this invention simplifies user's mobile experience and all electronic devices in general. User can control smart phones, wearable devices, home appliances, home automation devices, automotive vehicle electronics, and etc by a simple user interaction, changing user-activity.

### BRIEF DESCRIPTION OF THE SEVERAL VIEWS OF THE DRAWINGS

FIG. 1 illustrative scenario of current user experience with electronic devices

FIG. 2 one-to-many relationship among user-activities, electronic devices, and functions and settings of electronic devices for user-activity “jog” from scenario 100 of FIG. 1

FIG. 3 one-to-many relationship among user-activities, electronic devices, and functions and settings of electronic devices for user-activity “sleep” from scenario 100 of FIG. 1

FIG. 4 illustrative diagram of exemplary electronic device
402 input component
404 output component
406 control module
408 graphic module
410 network
412 memory
414 storage device
416 communication module
418 contextual mode of operation control module

FIG. 5 illustrative diagram of plurality of exemplary electronic devices identical to electronic device 400 in various embodiments

FIG. 6 illustrative diagram of potential user-activity detection options

FIG. 7 illustrative data structure for user-activity

FIG. 8 illustrative data structure for contextual modes of operation

FIG. 9 illustrative relationship diagram for user-activity and contextual modes of operation

FIG. 10 illustrative scenario of user experience with activity-centric contextual mode of operation

FIG. 11 illustrative architectural diagram for a smart phone with current practice

FIG. 12 illustrative architectural diagram for a smart phone of this invention

FIG. 13A illustrative flow chart in accordance with one embodiment of the invention (part 1 of 2)

FIG. 13B illustrative flow chart in accordance with one embodiment of the invention (part 2 of 2)

FIG. 14 illustrative home screenshot of this invention

FIG. 15 illustrative first screenshot of this invention

FIG. 16 illustrative screenshot of new user-activity editing screen

FIG. 17 illustrative screenshot of automatic detection editing screen

FIG. 18 illustrative screenshot of application activation editing screen

FIG. 19 illustrative screenshot of sensor input editing screen

FIG. 20 illustrative screenshot of Bluetooth input editing screen

FIG. 21 illustrative screenshot of activity-centric contextual mode of operation editing screen

FIG. 22 illustrative screenshot of application activation editing screen

FIG. 23 illustrative screenshot of primary device settings editing screen

FIG. 24 illustrative screenshot of peripheral device editing screen

FIG. 25 illustrative screenshot of peripheral device settings editing screen

FIG. 26 illustrative screenshot of new user-activity start confirmation screen

FIG. 27 illustrative screenshot of settings editing screen

FIG. 28 illustrative screenshot of new user-activity detection confirmation screen

FIG. 29 illustrative screenshot of new user-activity notification confirmation screen

FIG. 30 illustrative screenshot of no contextual mode alert screen

### DETAILED DESCRIPTION OF THE INVENTION

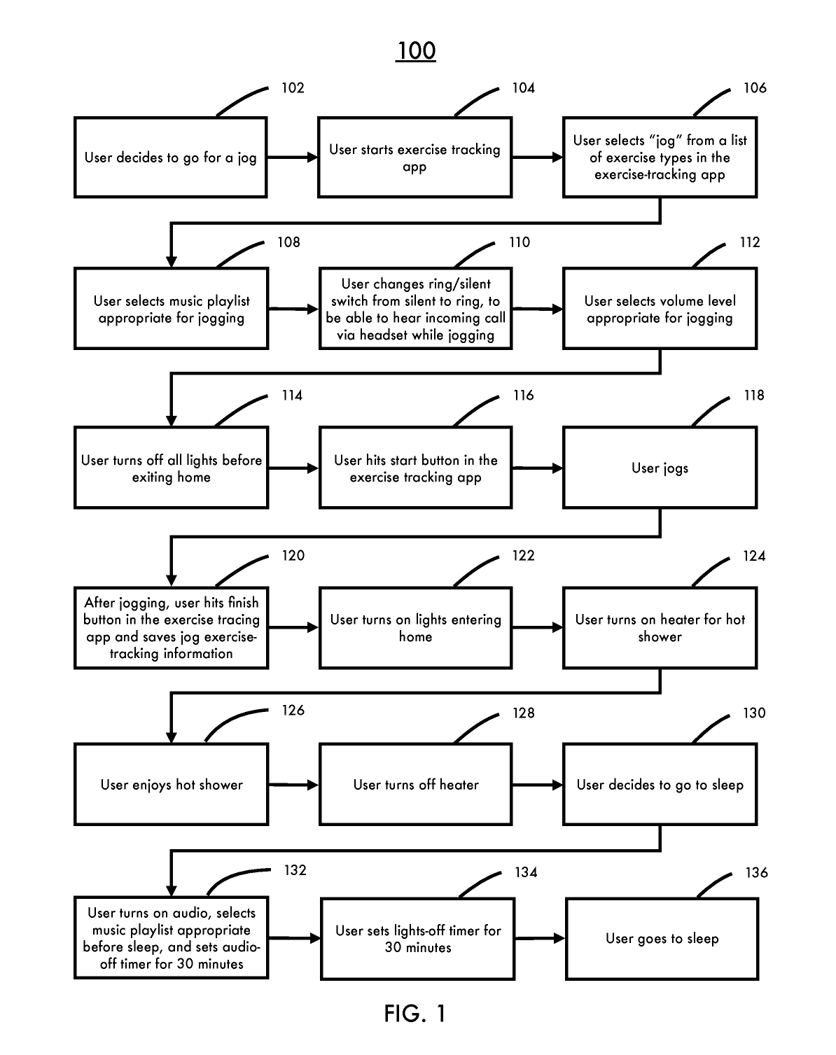

Systems and methods for supporting activity-centric contextual modes of operation for one or more electronic devices are provided and described with reference to FIGS. 1-30.

FIG. 1 shows an illustrative scenario 100 of current user experience with electronic devices when user engages jog and sleep activity. Scenario 100 may begin with user's intention to a new activity as first step 102 “user decides to go for a jog”. With next steps 104 and 106, said user starts exercise-tracking app and selects “jog” from a list of exercise types in the exercise-tracking app. With steps 108, 110, and 112, said user selects music playlist appropriate for jogging, changes ring/silent switch from silent to ring in order to hear incoming call via headset while jogging, and selects volume level appropriate for jogging. With steps 114, said user turns off all lights before exiting home. Said user is now all ready to start jogging. Said user hits start button in the exercise-tracking app as in step 116 and jogs as in step 118. With step 120, said user hits finish button in the exercise-tracing app after jogging and saves jog exercise-tracking information. With steps 122, 124, 126, and 128, said user turns on lights entering home, turns on heater, enjoys hot shower, and turns off heater when showers done.

Steps from 102 to 128 are related to user's jog activity and throughout the steps user interacts with 3 different electronic devices, smart phone, heater control system, and lighting control system. User's interaction with said 3 different electronic devices is to change functions and settings of said 3 different electronic devices to suit user's jog activity.

Steps from 130 to 136 show changes to user's activity in which after hot shower said user decides to go to sleep and changes functions and settings of electronic devices in order to suit user's new activity, “sleep”. For user-activity “sleep”, user turns on audio, selects music playlist appropriate before sleep, and sets audio-off timer for 30 minutes in step 132. In step 134 and 136, user sets lights-off timer for 30 minutes and goes to sleep. From step 130 to step 136, user interacts with 2 electronic devices, lighting control system and audio.

Illustrative user scenario 100 is an example of current user experience with electronic devices, which involves 2 user-activities (jog and sleep), 4 different electronic devices (smart phone, heater control system, lights control system, and audio), and numerous changes to functions and settings of said 4 electronic devices. Between shifts in user's activities, user constantly needs to activate/deactivate electronic devices and change functions and settings of said electronic devices to suit user's new activity. As more electronic devices become smarter and networked in future, user may enjoy with ever more functionalities but need to constantly change functions and settings between shifts in user's activities which results in added complexity to user interface.

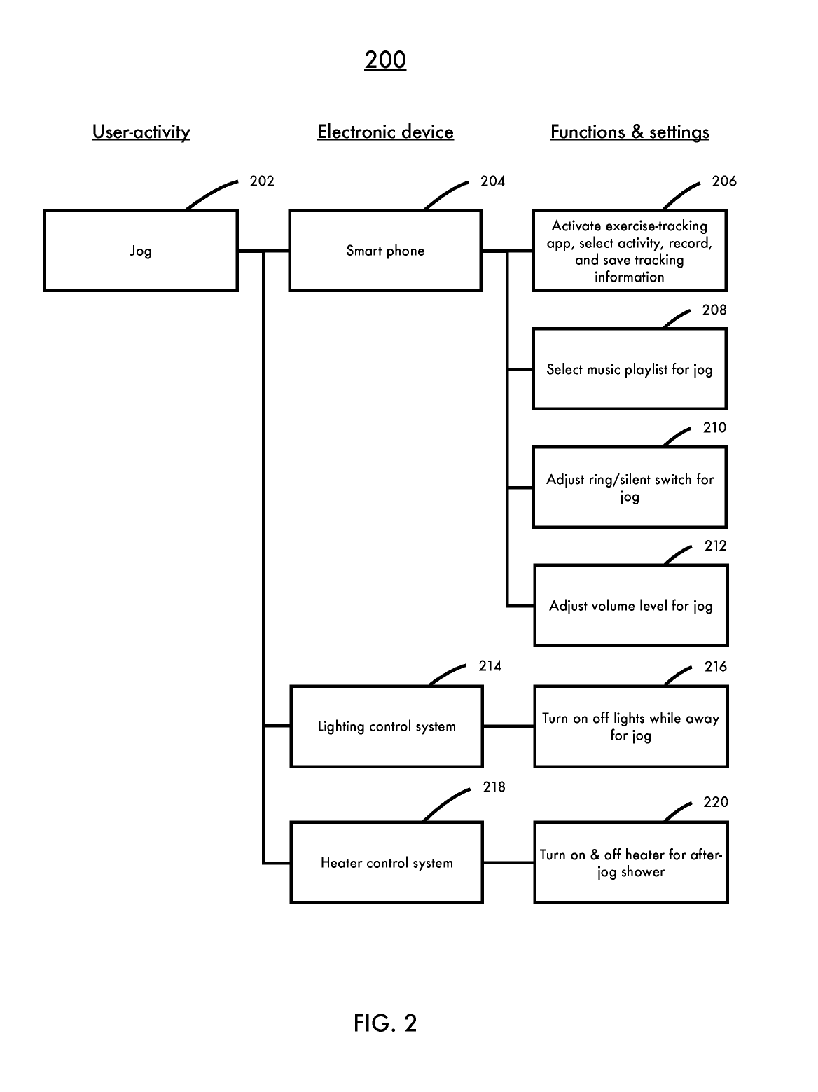

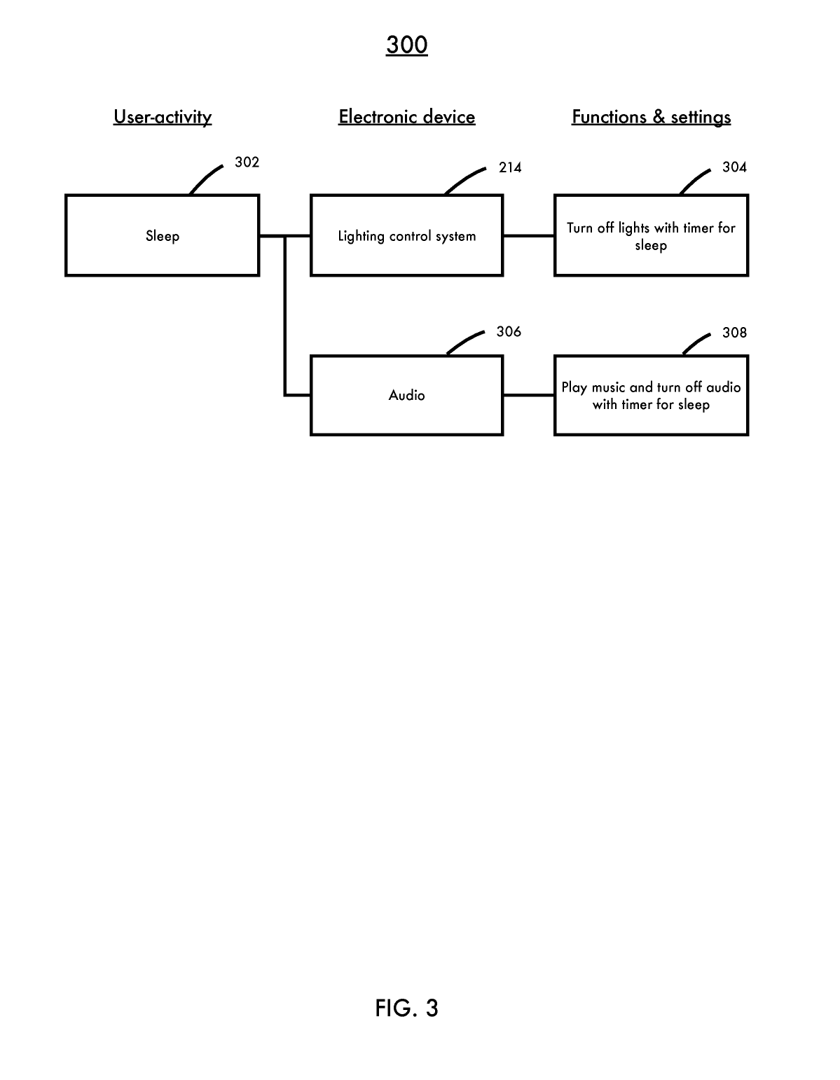

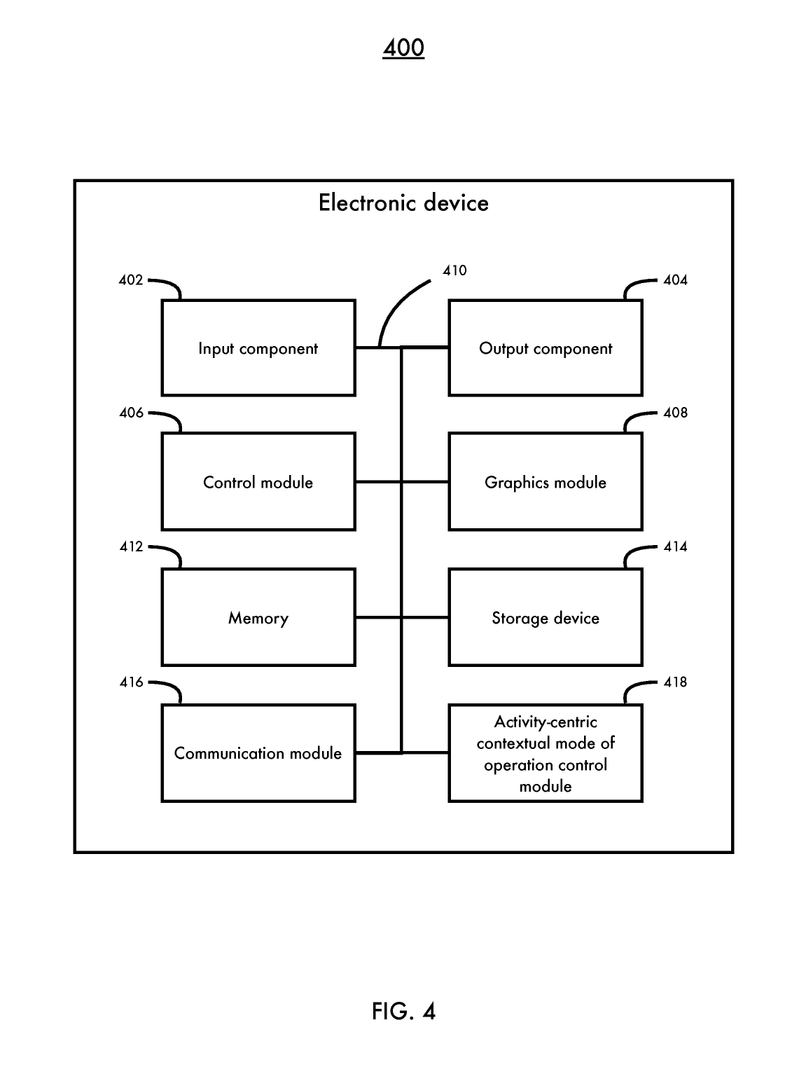

This invention proposes a solution to tackle the complexity within the user interface. In order to resolve the complexity, this invention uses user-activity as a common denominator to sort complex functions and settings of electronic devices and to group only required functions and settings of electronic devices with user's current activity. FIGS. 2 and 3 show illustrative relationship diagrams 200 and 300 among user-activity, electronic devices, and functions and settings for user-activity “jog” and “sleep” respectively, from illustrative user scenario 100. As shown in FIG. 2, user-activity “jog” 202 involves 3 different electronic devices (smart phone 204, lighting control system 214, and heater control system 218), and 6 different changes to functions and settings (206, 208, 210, 212, 216, and 220) of said electronic devices. FIG. 3 shows user-activity “sleep” 302 with 2 different electronic devices (lighting control system 214 and audio 306), and 2 different changes to functions and settings (304 and 308) of said electronic devices.

As shown in FIGS. 2 and 3, the one-to-many relationship among user-activities, electronic devices, and functions and settings of electronic devices is the key to this invention. This invention is using this one-to-many relationship to resolve the complexity and to simplify the user experience. When user-activity “jog” is detected, 6 different changes to functions and settings (206, 208, 210, 212, 216, and 220) can be automatically applied to the electronic devices 204, 214, and 218. When user-activity “sleep” is detected, 2 different changes to functions and settings (304 and 308) can be automatically applied to the electronic devices 214 and 306.

This invention identifies the fact that user changes functions and settings of electronic devices because user wants different behaviors from electronic devices for different user-activities, as described in illustrative scenario 100. Therefore, shift in user-activity is the root cause of multiple changes to functions and settings of electronic devices. This invention provides systems and methods that detects user-activity and automatically apply changes to functions and settings of electronic devices as predefined for said user-activity. The predefined changes to functions and settings of electronic devices are called “modes of operation” in this invention. Different user-activity has different modes of operation for electronic devices. Since this invention defines user-activity as user context, “modes of operation” for respective user-activity are thus defined as “activity-centric contextual modes of operation” in this invention. Activity-centric contextual modes of operation contain information on the mode or the state of electronic devices to which electronic devices change functions and settings when user shifts activity. Changing functions and setting may involve disabling, enabling or restricting access to one or more functionalities, applications, or assets of the electronic devices.

The functionalities may include, but are not limited to, any input functionalities (e.g., microphone), any output functionalities (e.g., audio level), any communication functionalities (e.g., Bluetooth), any graphics functionalities (e.g., display brightness), or any combination of the aforementioned types of functionalities. For example, a contextual mode of operation for “secret meeting” activity may disable microphone to prevent recording conversation and disable camera to prevent taking pictures.

A contextual mode of operation may alter the priority or the availability of one or more assets accessible to user of electronic devices. Asset may include, but are not limited to, any media assets (e.g., songs, videos), any electronic communication assets (e.g., e-mails, text messages, contact information), any other various assets (e.g., “favorite” links for internet browser), or any combination of the aforementioned types of assets. For example, a contextual mode of operation for “at-home” activity may disable work related or corporate confidential e-mails, contacts or favorite links.

FIG. 4 shows an embodiment of electronic device 400 that may be compatible with one or more activity-centric contextual modes of operation. Electronic device 400 can include, but not limited to any device or group of devices, such as music players, video players, game players, personal computers, printers, smart phones, tablet devices, phablet devices, smart watches, other wearable devices, digital personal assistants, other wireless communication devices, cameras, home appliances, home automation devices, electronic devices of transportation vehicle, interactive user interface devices such as kiosks, and combinations thereof. In some cases, electronic devices 400 may perform a single function (e.g., a device dedicated to vacuum floor) or, in other cases, electronic device 400 may perform multiple functions (e.g., device that vacuum floor and play music).

Electronic device 400 may be any portable, hand-held, wearable, implanted in human flesh, or other embodiments that allows user to use the device wherever said user travels. Alternatively, electronic device 400 may not be portable at all, but may instead be generally stationary, such as smart TVs or HVAC (heating, ventilation and air conditioning). Moreover, electronic device 400 may not be portable or stationary, but instead be mobile, such as electronic devices of transportation vehicles (car navigation system, vehicle dynamics control system or control system for airplane seats).

Electronic device 400 may include, among other components, input component 402, output component 404, control module 406, graphics module 408, bus 410, memory 412, storage device 414, communication module 416, and activity-centric contextual mode of operation control module 418. Input component 402 may include touch interface, GPS sensor, microphone, camera, neural sensors, or other means of detecting human activity and intention to an activity. Output components 404 may include display, speaker, or other means of presenting information or media to user. Electronic device 400 may include operating system or applications. Said operating system or said applications running on control module 406 may control functions and settings of electronic device 400. Said operating system or application may be stored in memory 412 or storage device 414. Graphics module 408 may include systems, software, and other means of presenting visual information or media to user. Electronic device 400 may communicate with one or more other electronic devices by using any means of communicating information with communication module 416. Communication module 416 may be operative to interface with the communications network using any suitable communications protocol including, but not limited to, Wi-Fi, Ethernet, Bluetooth, NFC, infrared, cellular, any other communication protocol, or any combinations thereof. Activity-centric contextual mode of operation control module 418 may be implemented in software in some embodiments, or be implemented in hardware, firmware, or any combination of software, hardware, firmware in other embodiments. Activity-centric contextual mode of operation control module 418 may use information from other components of electronic device 400 (e.g., input component 402, control module 406, communication module 416) to detect a new user-activity. For example, GPS information from GPS sensor of input component 402 may be used to detect “study” user-activity with GPS information at a library. Communication module 416 may receive “house cleaning” user-activity from a vacuum cleaner.

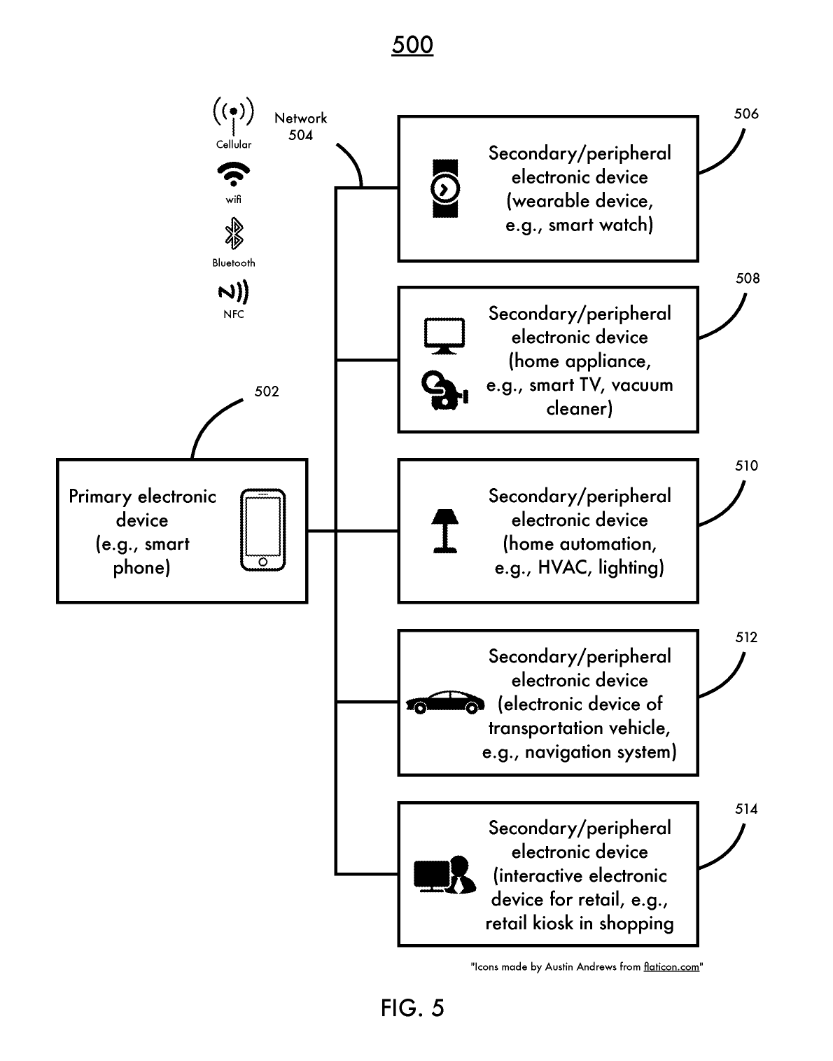

Systems and methods for activity-centric contextual modes of operation may include a single electronic device in identical embodiment as electronic device 400, a single electronic device in other embodiments, or plurality of electronic devices in either identical or different embodiments as electronic device 400. FIG. 5 shows an illustrative diagram 500 of plurality of exemplary electronic devices in various embodiments that may be compatible with activity-centric contextual modes of operation. In the example of FIG. 5, smart phone 502, wearable device 506, home appliance 508, home automation 510, electronic device of transportation vehicle 512, and interactive electronic device for retail 514 are shown as various embodiments of electronic device 400, all connected via network 504. Network 504 may be wireless or wired using communication protocol including, but not limited to, Wi-Fi, Bluetooth, Ethernet, transmission control protocol/internet protocol (“TCP/IP”), global system for mobile communication (“GSM”), code division multiple access (“CDMA”), any other communication protocol, or any combination thereof. Electronic devices in FIG. 5 may communicate with each other to share information about contextual modes of operation and/or current user-activity. Any of electronic devices in FIG. 5 may detect new user-activity and communicate the information about the user-activity or respective contextual mode of operation to other electronic devices within the network 504. In the example of FIG. 5, smart phone 502 is called primary electronic device while all other embodiments are called secondary or peripheral electronic device. Any embodiment of electronic device in this invention may be primary electronic device or secondary/peripheral electronic device. For ease of understanding when describing contextual modes of operation for plurality of electronic devices, electronic device that user primarily interacts is called primary electronic device while the rest of non-primary electronic devices within network are called secondary/peripheral electronic devices.

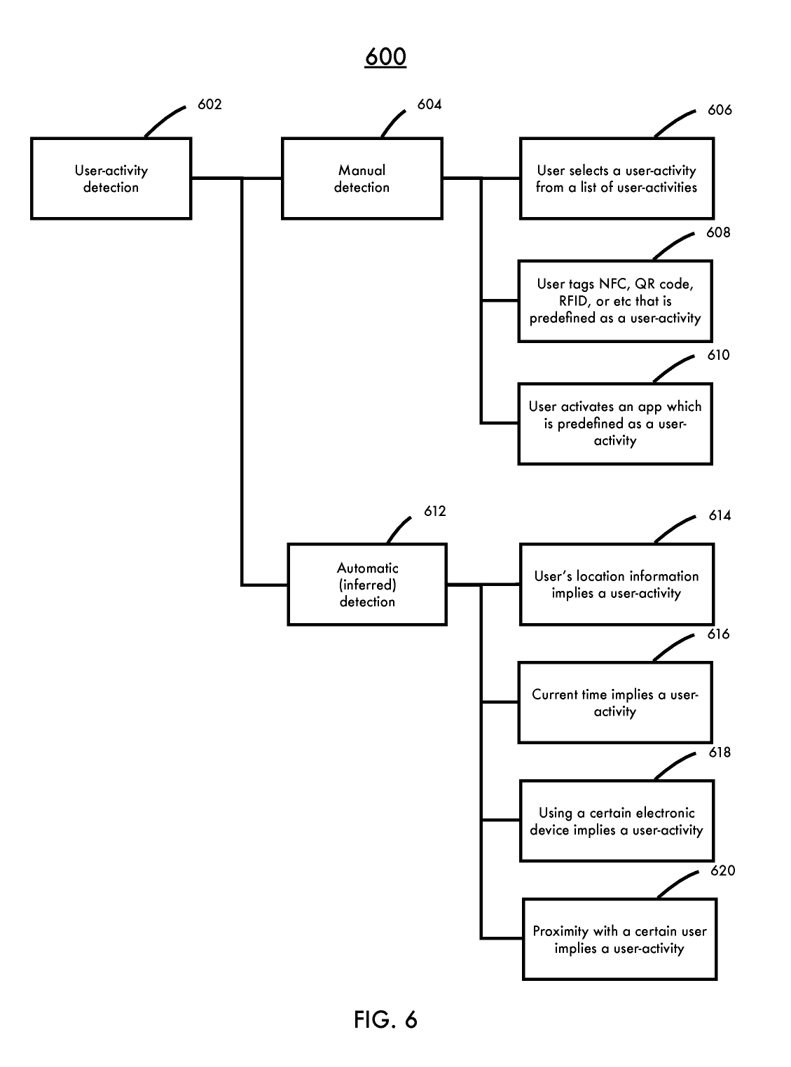

This invention provides systems and methods that detect user-activity as user context. Detecting user-activity may include user's explicit input or implicit assumption. In other words, user may manually input user's activity or electronic devices may infer user-activity by analyzing information available. An illustrative diagram 600 of potential options to detecting user-activities is shown in FIG. 6.

As shown in FIG. 6, user-activity detection 602 may take place either manually as in case 604 or automatically as in case 612. Manual detection may include, but not limited to, cases where user selects a user-activity from a list of user-activities as in case 606, user tags NFC, QR code, RFID, or other means of tagging that is predefined as a user-activity as in case 608, or user activates an app which is predefined as a user-activity as in case 610. Manual detection involves user's direct action towards user's intention to a user-activity. In controversy, automatic detection infers user-activity from implicit information available. Automatic detection may include, but not limited to, cases where user's location information implies a user-activity as in case 614, current time implies a user-activity as in case 616, using a certain electronic device implies a user-activity as in case 618, or proximity with a certain user implies a user-activity as in case 620.

Any means of user's explicit manual input may include, but not limited to, internal inputs using input components of said electronic device itself (e.g., touch screen input of user's smart phone) or external inputs using input components of other electronic devices that are connected to said electronic device via network (e.g., wearable device input such as smart watch connected to user's smart phone).

Any means of automatic detection may include, but not limited to, location-based sensors, any means of tagging, calendar entry, or other detection circuitries (e.g., “work” activity with GPS within office premise, “coffee break” activity with Starbucks Wi-Fi connection, “shopping” activity with an NFC tagged in a shopping mall, “meeting” activity with calendar entry for meeting, “wake-up” activity with alarm clock entry or “driving” activity with in-car Bluetooth connection). As technologies mature in future, motion analysis, neural analysis and other means of detecting user-activity or intention to user-activity may be used for automatic detection of user-activity.

User-activity detection 602 may take place any time within the lifecycle of said new user-activity. For example, a new user-activity may be detected in advance, in transition, in progress, at the end, or afterwards of said new user-activity.

When a new user-activity is detected, a comprehensive user context is identified using the principle of 5W1H (When, Where, Who, What, Why, How) from linguistic grammar to gather information and get the complete story on user-activity. Therefore, when systems and methods of this invention detect user-activity, this invention may also detect and record, but not limited to, time (When), place (Where), user group (Who), object (What), intention (Why), and other contextual information (How) associated with detected user-activity.

Using the principle of 5W1H to identify user-activity as user context is a substantial innovation from current practice to identify user context. Since smart phones have been introduced, location awareness has been the most prevalent information as user context. However, as breadth and functionalities of electronic devices grow, identifying user context with only location information has had limitations. Different technologies, such as accelerometer, gesture recognition and video analytics, have been developed to identify user context beyond location awareness but said different technologies have lacked a framework to define “comprehensive” user context as a whole. Using the principle of 5W1H as a framework to define user-activity as user context allows this invention to gather information and get the complete story of user's current context, as the principle does in linguistic grammar.

In order to detect time (When from 5W1H) of user-activity, timer or clock function of electronic devices may be used to measure relative or absolute time information of user-activity. To detect place or location (Where from 5W1H) of user-activity, location awareness technologies, such as, but not limited to, GPS, Bluetooth, Wi-Fi, NFC tags, or combinations thereof, may be used. User group information (Who from 5W1H) may use, but not limited to, user identification information stored in electronic devices, NFC tags, RFID chips, barcode, facial recognition, finger print detection, iris recognition, or other biometric identification technologies to detect a user or a group of users associated with user-activity. Object information (What of 5W1H) may include, but not limited to, information about any objects associated with user-activity, such as what user is carrying while user-activity “jogging” or what user is eating while user-activity “dining”. User intention (Why of 5W1H) may include user's explicit input to identify intention or inferred assumption from implicit information. When user is engaged in user-activity “shower”, user may input “after jog” as intention or electronic device may assume “after jog” intention from previous user-activity “jog”. How from 5W1H may include multitudes of other contextual information on user or environment associated with user-activity, such as, but not limited to, user's mood or weather. Systems and methods with this invention may include all or part of these 5W1H depending on requirements for user context awareness.

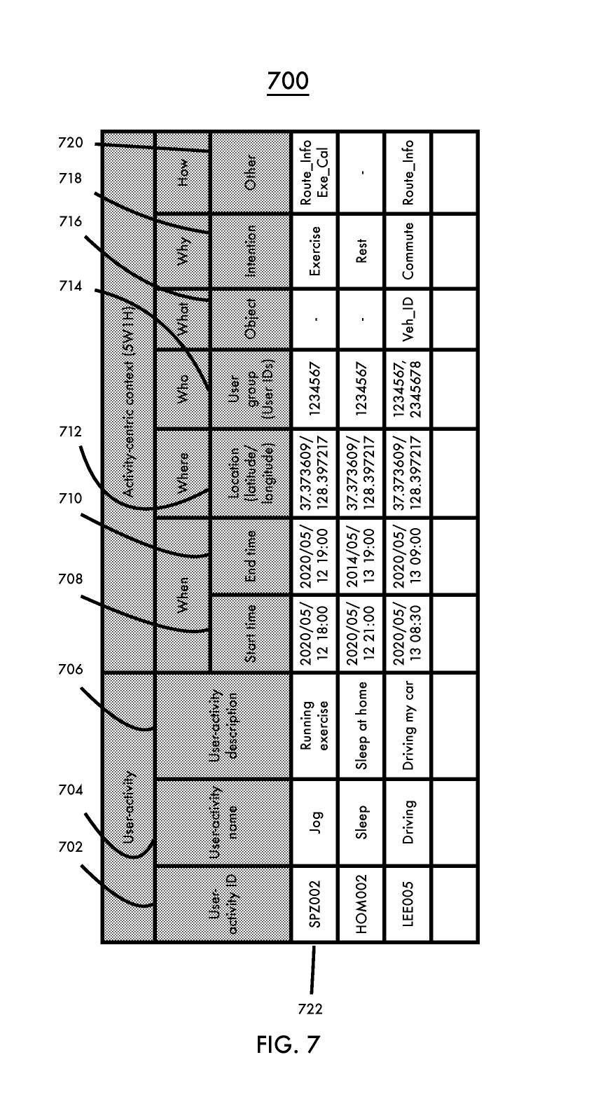

The profile or definition associated with a user-activity may take a standardized format as in data structure 700 of FIG. 7, to save and access in memory or storage and to facilitate portability and compatibility of the information with a wide range of electronic devices. Data structure may include, but not limited to, user-activity ID 702, user-activity name 704, user-activity description 706, start time 708, end time 710, location in latitude and longitude 712, user group 714, associated object 716, intention 718, other contextual information 720. Data structure 700 may be stored on electronic device 400 (FIG. 4), for example, in memory 412 (FIG. 4) or storage device 414 (FIG. 4). Alternatively or additionally, part or all of data structure 700 may be located on some external system or other device and may be communicated to electronic device 400.

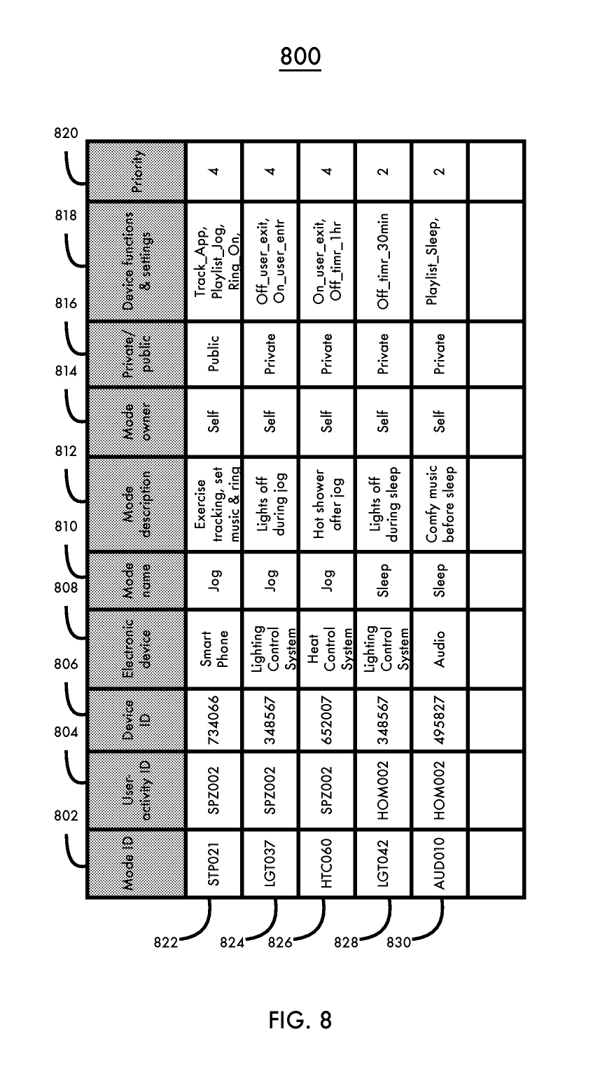

When a new user-activity is detected along with 5W1H data as user context, changes to functions and settings of electronic devices for the detected user-activity are applied. The changes to functions and settings of electronic devices are defined as “activity-centric contextual modes of operation” in this invention. “Activity-centric contextual modes of operation” represent modes of operation for a given user-activity as user context. Activity-centric contextual modes of operation are predefined for each user-activity so that when a new user-activity is detected, respective contextual modes of operation are accessed from memory 412 or storage device 414 and applied to electronic devices. FIG. 8 shows an illustrative data structure 800 for potential activity-centric contextual modes of operation from scenario 100 of FIG. 1 that may be used to save and access in memory 412 or storage device 414, and to communicate amongst electronic devices of this invention. In some embodiments, in addition to specifying the valid activity-centric contextual modes of operation for the user-activity, the profile or definition may also include references to assets (e.g., songs, videos, emails, etc) or applications to be downloaded or synchronized to the electronic device 400 when applying said activity-centric contextual modes of operation.

Data structure for contextual mode of operation may include, but not limited to, mode ID 802, user-activity ID 804, device ID 806, electronic device 808, mode name 810, mode description 812, mode owner 814, public versus private mode identifier 816, device functions and settings 818 that need to change, and mode priority 820. Mode ID 802 has corresponding user-activity ID 804 so that when new user-activity of corresponding user-activity ID is detected, the contextual mode of operation with corresponding mode ID 802 may be applied to electronic device with corresponding device ID 806. For example as in row 822 of FIG. 8, when new user-activity with user-activity ID SPZ002 is detected, activity-centric contextual mode of operation with mode ID STP021 is applied to smart phone device with device ID 734066. Mode name 810 and mode description 812 may define the name and description of activity-centric contextual modes. Mode owner 814 and public versus private mode identifier 816 may define the editors of contextual modes and distinguish whether the modes may be shared for public usage. Device functions and settings 818 may define the changes to functions and settings of electronic device 808. The changes may include disabling, enabling or restricting access to one or more functionalities, applications, or assets of the electronic device 808. Mode priority 820 defines relative priority against other modes.

Rows 822, 824, 826, 828, 830 in FIG. 8 show exemplary activity-centric contextual modes of operation for scenario 100 of FIG. 1. In scenario 100, user needs to change functions and settings of smart phone for user-activity “jog”. In this invention the changes required to device functions and settings of smart phone for user-activity “jog” are predefined and automatically applied to smart phone when user-activity “jog” is detected. As defined in row 822, if user-activity “jog” with user-activity ID SPZ002 is detected, device functions and settings are automatically applied as defined in column 818 of row 822. The changes are activating exercise tracking application (Track_App), set music playlist to “jog” (Playlist_Jog), and set ring tone on (Ring_On). Each row defines one activity-centric contextual mode of operation for each electronic device for corresponding user-activity. Therefore, in this illustrative example, there are 3 electronic devices involved for user-activity “jog and thus 3 corresponding activity-centric contextual modes of operation as in rows 822, 824, and 826. In the same manner, 2 corresponding activity-centric contextual modes of operation for “sleep” user-activity as in rows 828 and 830 are applied when “sleep” user-activity is detected.

Custom, user-defined activity-centric contextual mode of operation for a user-activity may be defined in some embodiments. Mode owner information 814 defines the original editor of the mode. Private/public identifier 816 defines whether an activity-centric contextual mode of operation is for private-use or for public-use. User may define all or part of information for activity-centric contextual mode of operation and said mode may be “published” to network server so that other users may use the custom activity-centric contextual mode of operation, or vise versa.

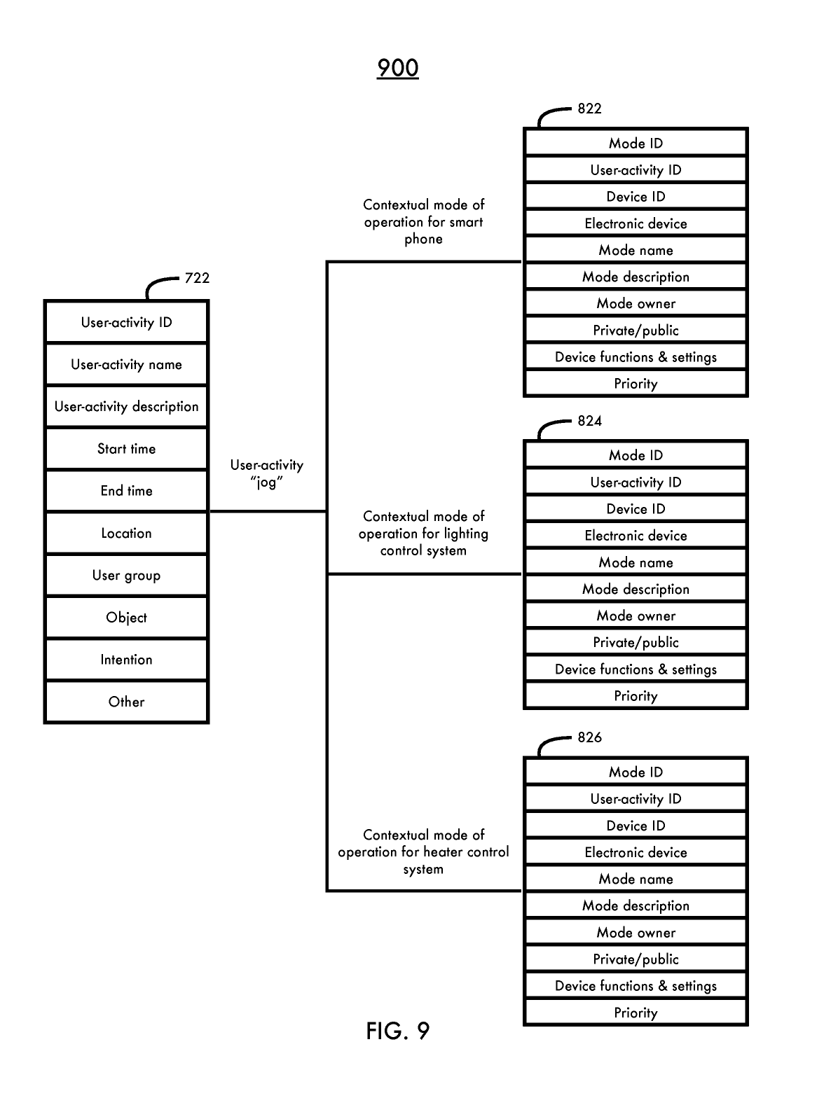

FIG. 9 shows an illustrative relationship diagram 900 for user-activity and contextual modes of operation for “jog” activity example from scenario 100 of FIG. 1. FIG. 9 shows that user-activity “jog” as defined in row 722 from FIG. 7 has 3 different activity-centric contextual modes of operation as defined in row 822, 824, and 826 from FIG. 8. Therefore, when user-activity “jog” as defined in row 722 is detected activity-centric contextual modes of operation as defined in row 822, 824, and 826 are applied to corresponding electronic devices.

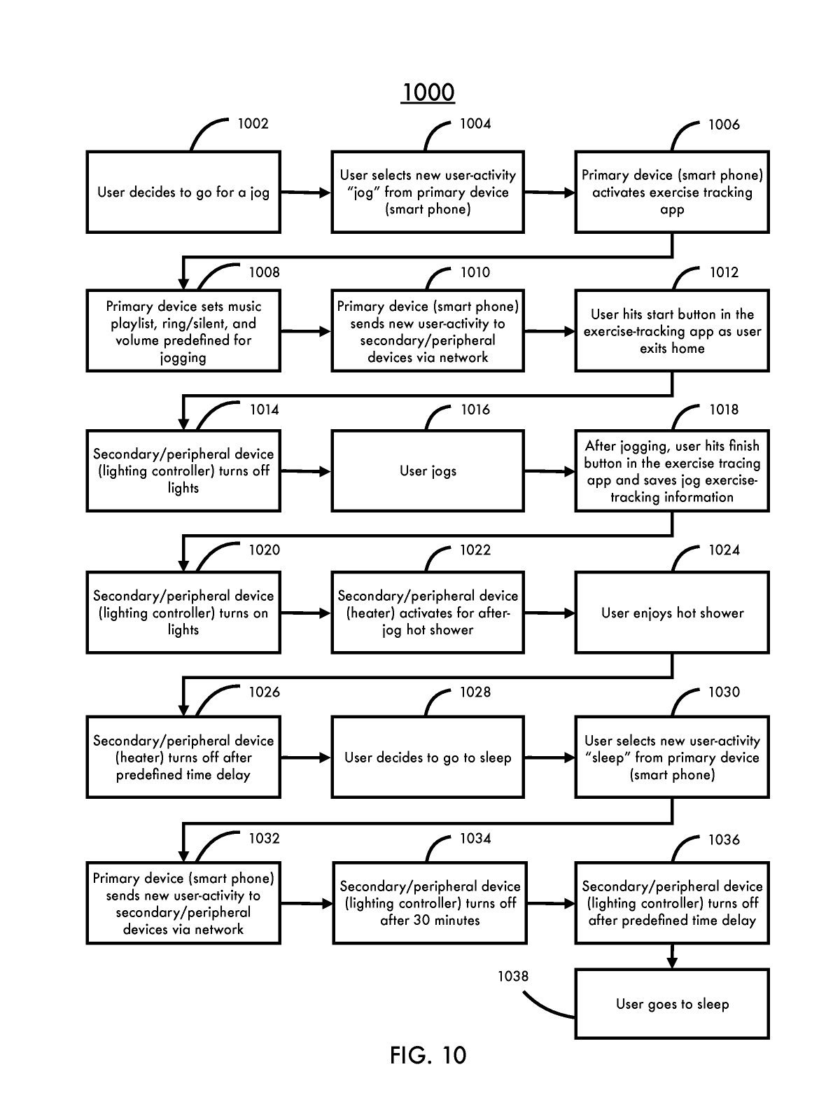

FIG. 10 shows an illustrative scenario 1000 of user experience with activity-centric contextual modes of operation. Scenario 1000 describes a potential user experience with electronic devices when user engages jog and sleep activity, same activities as scenario 100 of FIG. 1. Scenario 1000 may begin with user's intention to a new activity as first step 1002 “User decides to go for a jog”. Next, user selects new user-activity “jog” from primary device (smart phone) as in step 1004, instead of starting exercise-tracking app and selecting “jog” from a list of exercise types in the exercise-tracking app as in step 104 and 106 of FIG. 1. This is the difference in user interface between this invention and current practice. In this invention user's main interaction is selecting user-activity while in current practice user's main interaction is with apps. Once user's activity is detected, activity-centric contextual modes of operation are automatically applied as in steps 1006, 1008, 1014, 1020, 1022, and 1026. Primary device (smart phone)'s activity-centric contextual modes of operation for user-activity “jog” is to activate exercise tracking app, to select music playlist predefined for jogging, to change ring/silent setting from silent to ring, and to change volume setting to predefined volume as in steps 1006 and 1008. As in step 1010, primary device (smart phone) sends new user-activity to secondary/peripheral electronic devices via network so that the secondary/peripheral electronic devices can apply their activity-centric contextual modes of operation for user-activity “jog”. As user exits home, user may hit start button in the exercise-tracking app as in step 1012. As a secondary/peripheral electronic device, lighting controller's activity-centric contextual mode of operation is to turn off as user starts jogging as in step 1014 and to turn back on when user finishes jogging as in step 1020. After step 1016 of jogging, user may hit finish button in the exercise-tracing app and save jog exercise-tracking information as in step 1018. As another secondary/peripheral electronic device, heater's activity-centric contextual mode of operation is to activate as user finishes jog as in step 1022, wait until user is done with step 1024 of enjoying shower, and deactivate after a predefined time as in step 1026.

In the same notion as user-activity “jog”, when user decides to go to sleep as in step 1028, user only needs to select new user-activity “sleep” from primary device (smart phone) as in step 1030, and primary device (smart phone) sends new user-activity to secondary/peripheral devices via network as in step 1032. Consequently as secondary/peripheral electronic devices, audio and lighting controller automatically play predefined playlist and turn themselves off after predefined time delay as in steps 1034 and 1036. Finally, user may go to sleep as in step 1038.

In this scenario 1000 with activity-centric contextual modes of operation, user does not need to hassle with complexity of functionalities. User's main interactions are selecting “jog” and “sleep” from user-activity list as in steps 1004 and 1030 respectively. Once activity-centric contextual mode of operation controller detects user-activity “jog” and “sleep”, primary and secondary/peripheral electronic devices automatically apply activity-centric contextual modes of operation for “jog” and “sleep” user-activity respectively. Compared to scenario 1000 of this invention, current practice scenario 100 has more user interaction with apps, functions, and settings of electronic devices. In scenario 100, user keeps activating/deactivating and changing individual functions and settings of electronic devices as user changes activity. In scenario 1000 of this invention, user's interaction is minimal and intuitive. User simply selects user-activity and almost all of required changes are applied automatically as predefined.

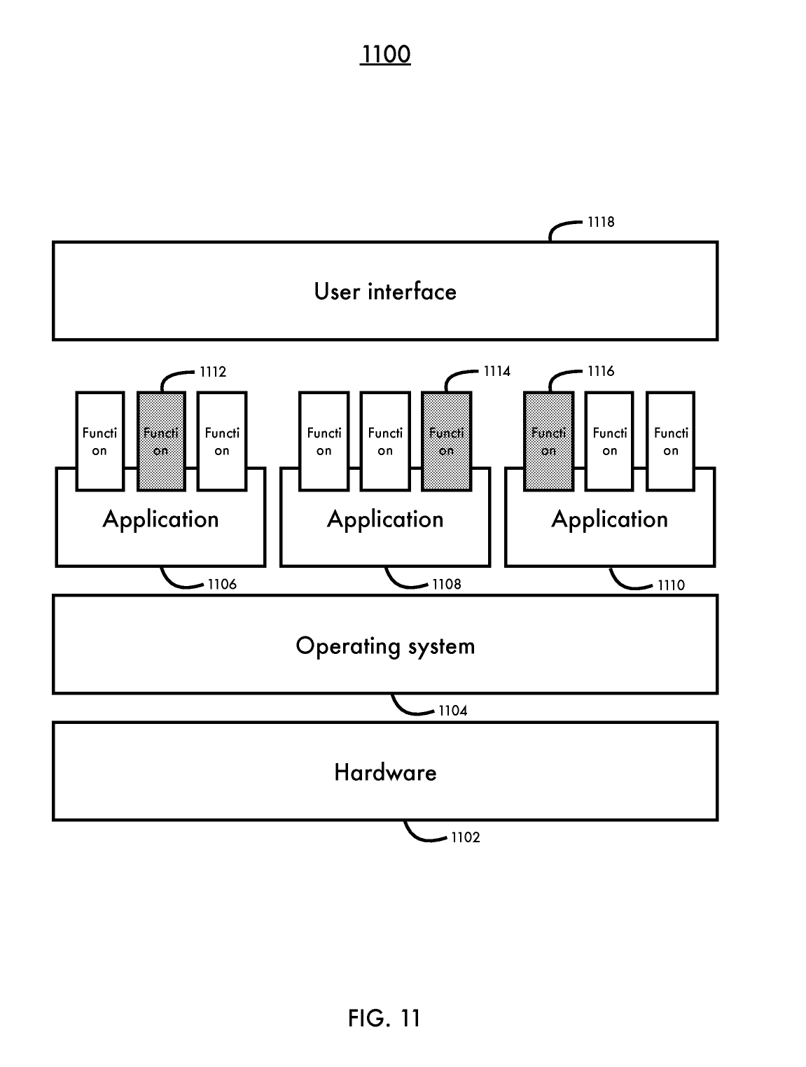

This invention changes user interaction from individual functions and settings to selecting user-activity. FIG. 11 shows an illustrative architectural diagram 1100 for a smart phone with current practice. Current architecture in FIG. 11 may include 4 basic layers, hardware layer 1102, operating system layer 1104, applications layer with applications 1106/1108/1110, and user interface layer 1118. For example, when user changes activity and need to change functions 1112, 1114, and 1116 of applications 1106, 1108, and 1110, said user does so directly via user interface layer 1118. Thus, user interface is directly linked to functionalities of applications.

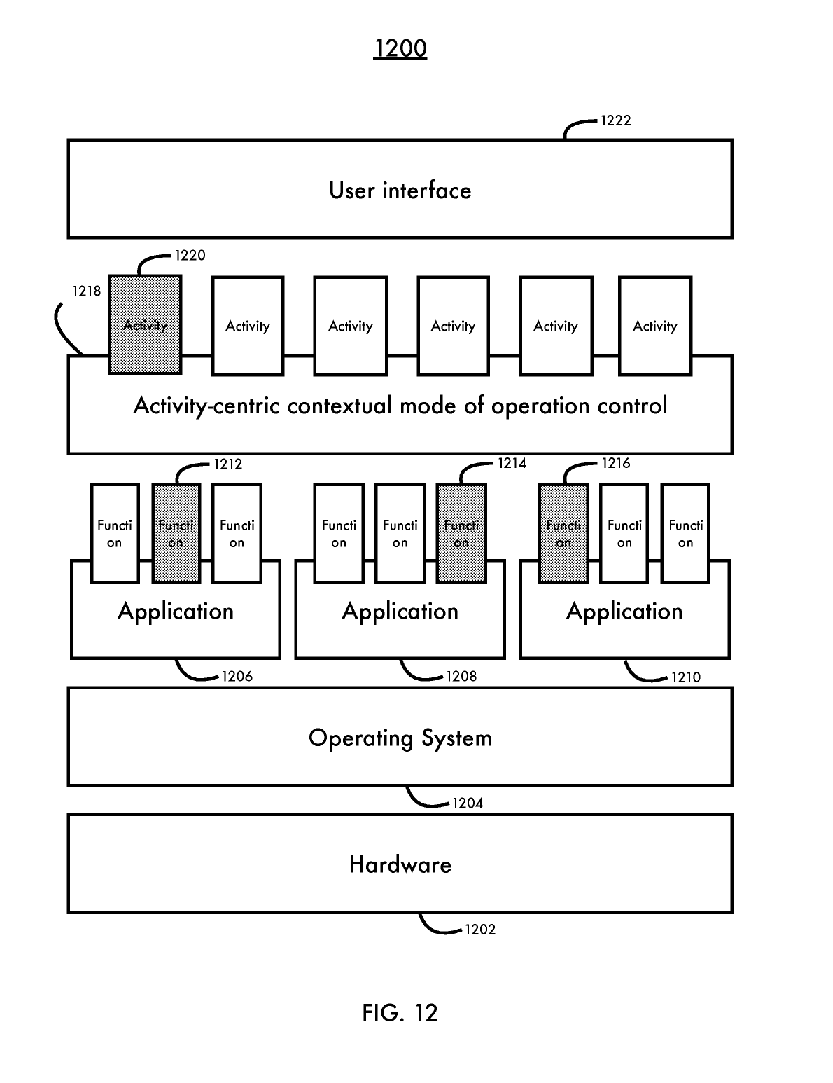

FIG. 12 shows an illustrative architectural diagram 1200 for a smart phone of this invention. New architecture with this invention may include 5 basic layers, hardware layer 1202, operating system layer 1204, applications layer with applications 1206/1208/1210, activity-centric contextual mode of operation control layer 1218, and user interface layer 1222. In this example, when user changes activity and need to change functions 1212, 1214, and 1216 of applications 1206, 1208, and 1210, said user only needs to select activity 1220 and activity-centric contextual mode of operation control layer 1218 automatically applies activity-centric contextual mode of operation for user-activity 1220, which is to change functions 1212, 1214, and 1216 of applications 1206, 1208, and 1210. Thus, user interface is linked to activity-centric contextual mode of operation and indirectly linked to functionalities of applications, unlike current practice shown in FIG. 11.

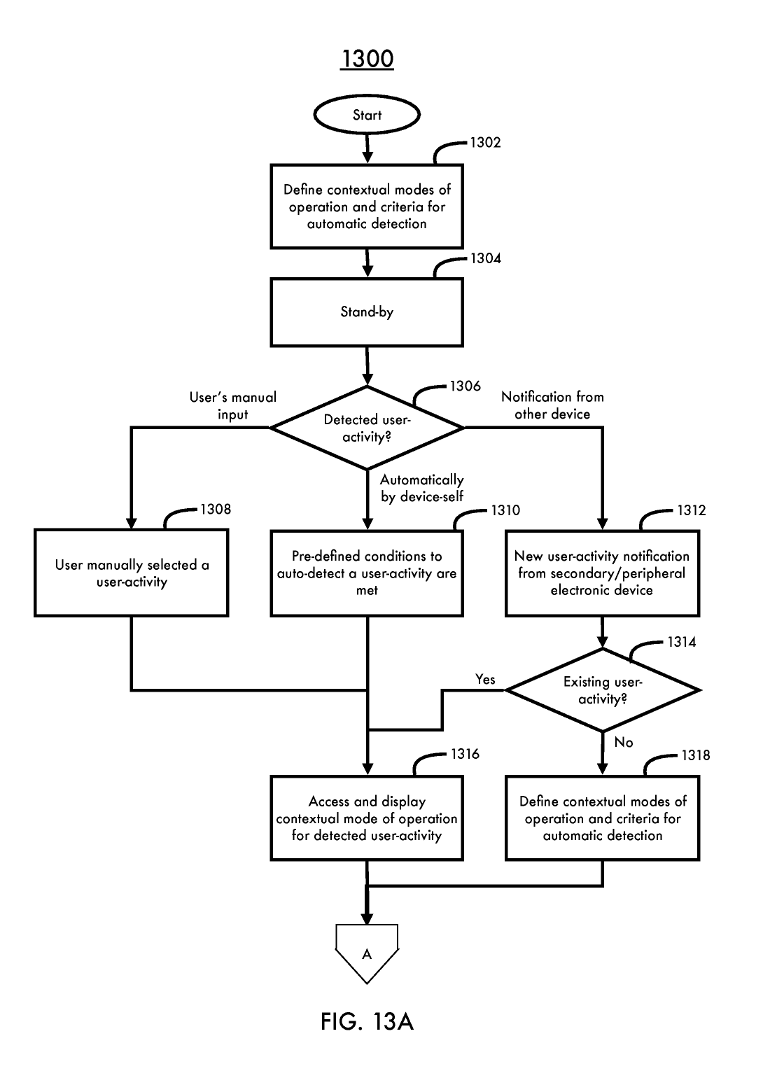

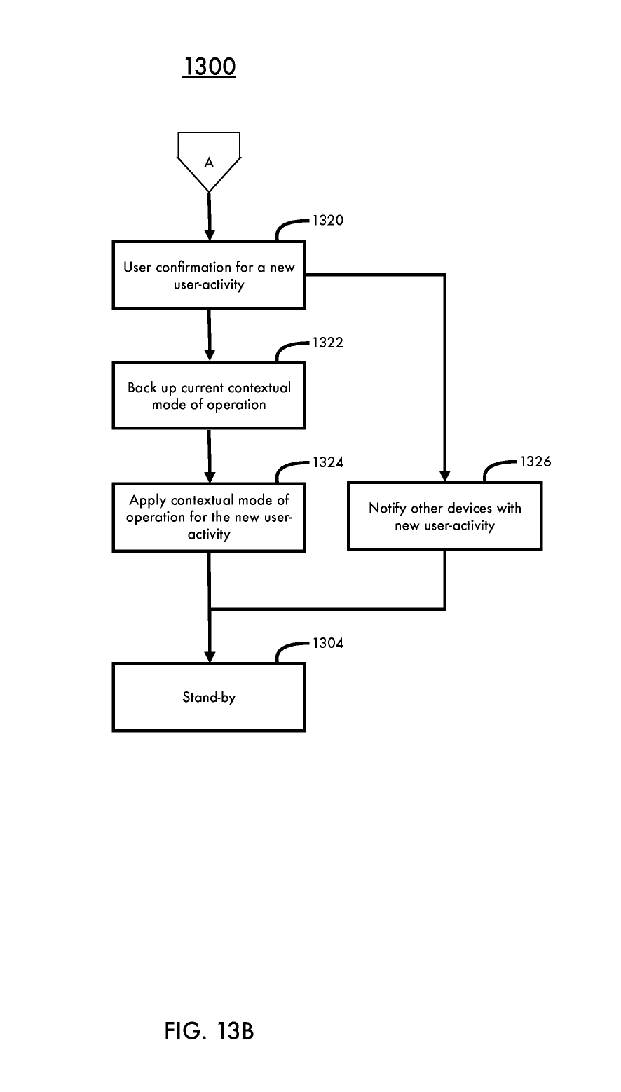

FIGS. 13A and 13B show an illustrative flow chart 1300 in accordance with one embodiment of the invention, as part 1 and part 2 respectively. Flow chart 1300 provides an exemplary process of using this invention. As in step 1302, user may define respective activity-centric contextual modes of operation for a user-activity and criteria for automatic detection. Activity-centric contextual modes of operation may be defined by editing within electronic devices. Activity-centric contextual modes of operation may also be defined by receiving and further editing predefined activity-centric contextual modes of operation from another electronic devices or from network storage using any communication mechanism available to the electronic devices. When editing is done, said activity-centric contextual modes of operation may be saved to electronic device, to a network storage, or combination of both. Within step 1302, user may also define automatic detection criteria for respective user-activity along which is used to automatically detect a new user-activity as in step 1310.

Once activity-centric contextual modes of operation and automatic detection criteria are defined in step 1302, electronic device awaits for a new user-activity detection as in step 1306 while in stand-by as in step 1304. User-activity may be detected in various ways as shown in steps 1308, 1310, and 1312. As in step 1308, user may manually select a user-activity from a predefined list of user-activity. User's manual selection of a new user-activity is an explicit user expression to a new user-activity or user's intention to user-activity. As in step 1310, electronic devices of this invention may automatically detect a new user-activity by monitoring the criteria defined in step 1302. When predefined criteria defined in step 1302 are met, electronic device may confirm a new user-activity with user as in step 1320.

As in step 1312, secondary/peripheral electronic devices may notify a new user-activity and the user-activity may be scanned in memory 412 or storage 414 to check if predefined activity-centric contextual mode of operation exists as in step 1314. If predefined activity-centric contextual mode of operation does not exist in memory 412 or storage 414, user may edit a new contextual mode of operation as in step 1318.

Once activity-centric contextual mode of operation for new user-activity is accessed from memory 412 or storage device 414 as in step 1316, or newly defined as in step 1318, user confirmation step 1320 is executed before shifting to new user-activity. After user confirmation step 1320, current activity-centric contextual mode of operation is backed up for possible later use to memory 412, to storage device 414, to network storage, or combinations thereof as in step 1322. As in step 1324, the activity-centric contextual mode of operation is applied to the electronic device. That is predefined changes to functionalities of said electronic device are applied. Finally, “confirmed” new user-activity is notified to other electronic devices as in step 1326 and the electronic device resumes to stand-by step 1304.

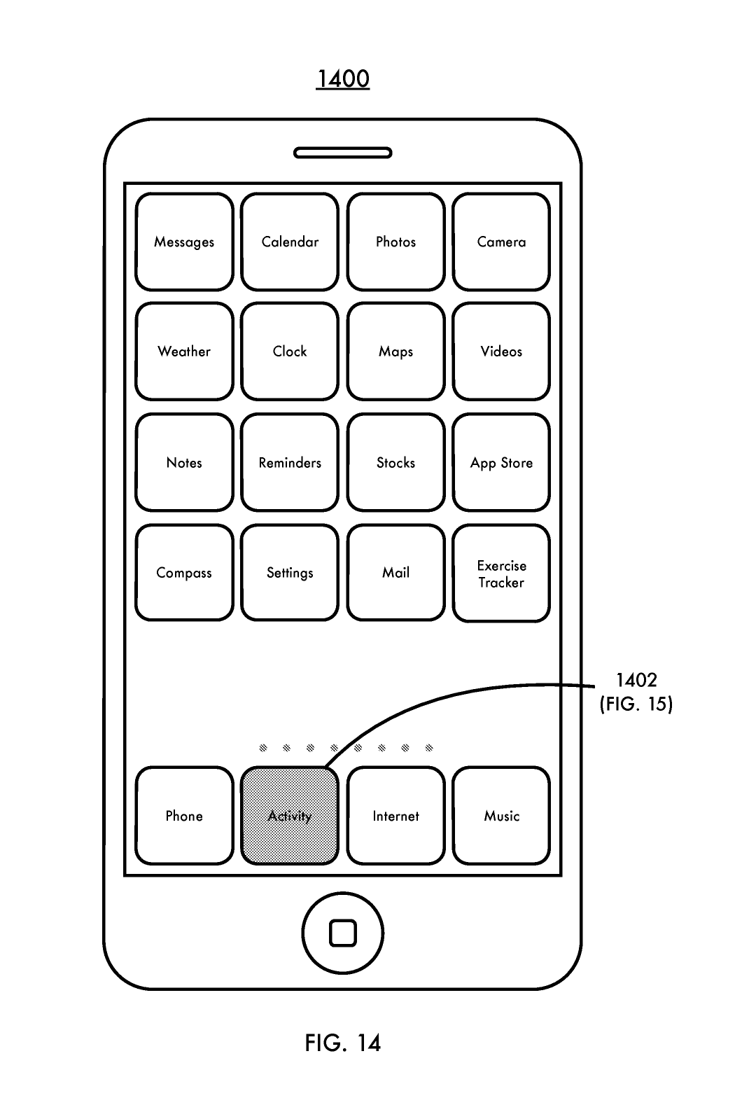

FIG. 14 to FIG. 30 shows illustrative screenshots for an embodiment of this invention with a smart phone example. The screenshots may be used along with scenario 1300 from FIGS. 13A and 13B to understand the process of using the invention as well as making the invention. The screenshots provide details with which person of ordinary skill in operating system programming of electronic devices could make and use the invention without extensive experimentation. Although lack of public application programming interface (API) for controlling functionalities of electronic devices prevent public programmers to make prototype of this invention, operating system programmers within manufacturer of electronic devices could make this invention with descriptions in this specification.

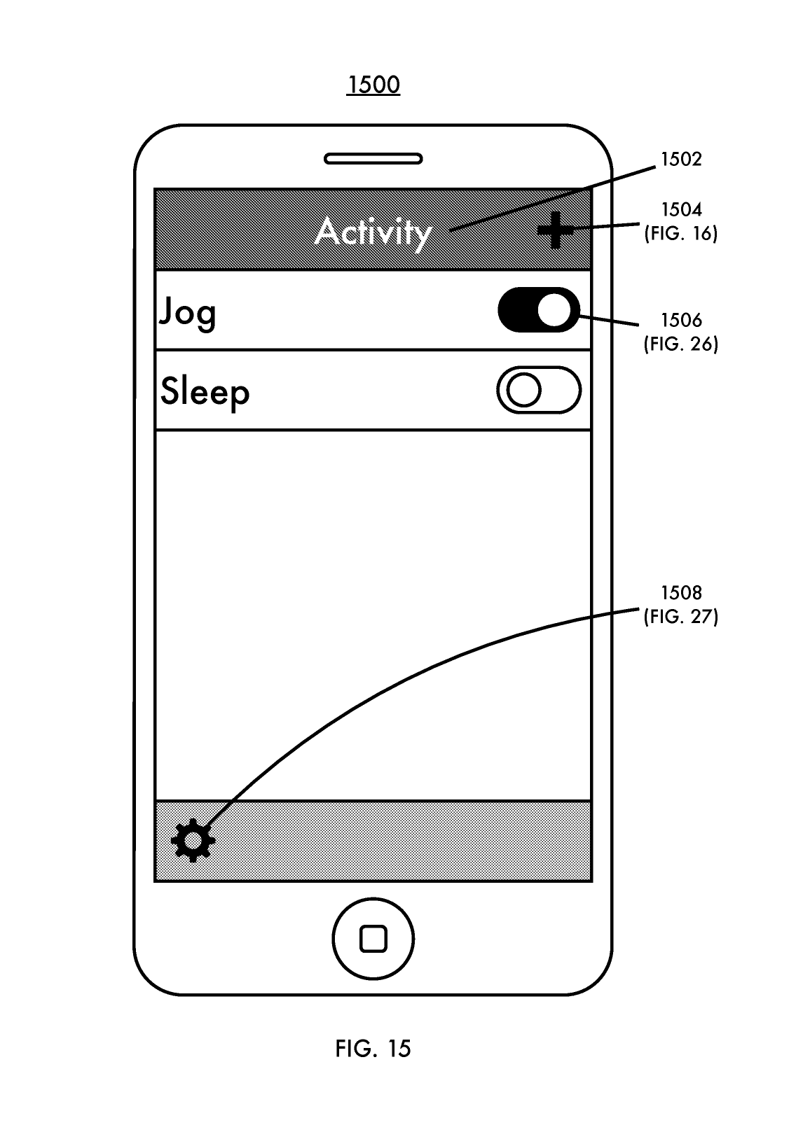

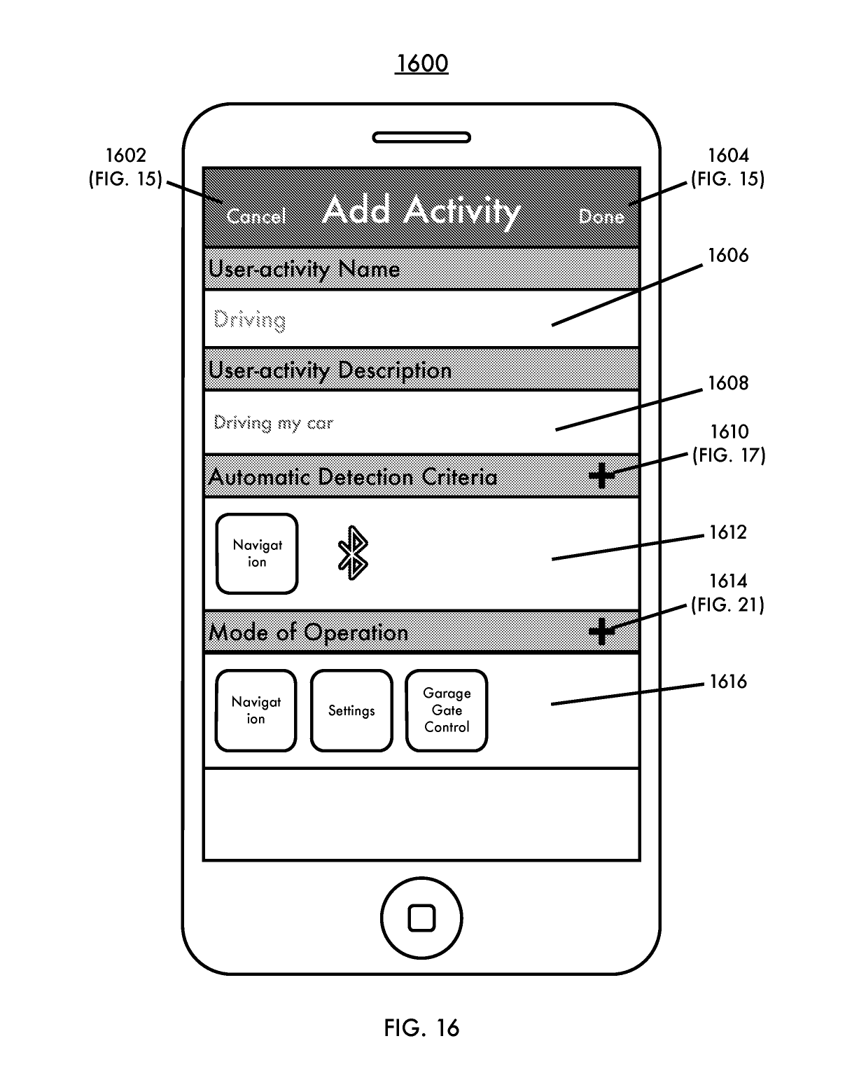

FIG. 14 shows an illustrative home screenshot 1400 of this invention. In this embodiment, home screen has “Activity” icon 1402, which may segue to the first screen of this invention as in FIG. 15 when touched. In some other embodiments, electronic device may have other means of activating activity-centric contextual mode of operation, such as separate physical button or holding down an existing button for certain amount of time. FIG. 15 shows an illustrative first screenshot of this invention with page title 1502, “add new user-activity” button 1504, table with existing user-activities, user-activity selection slider 1506, and settings button 1508.

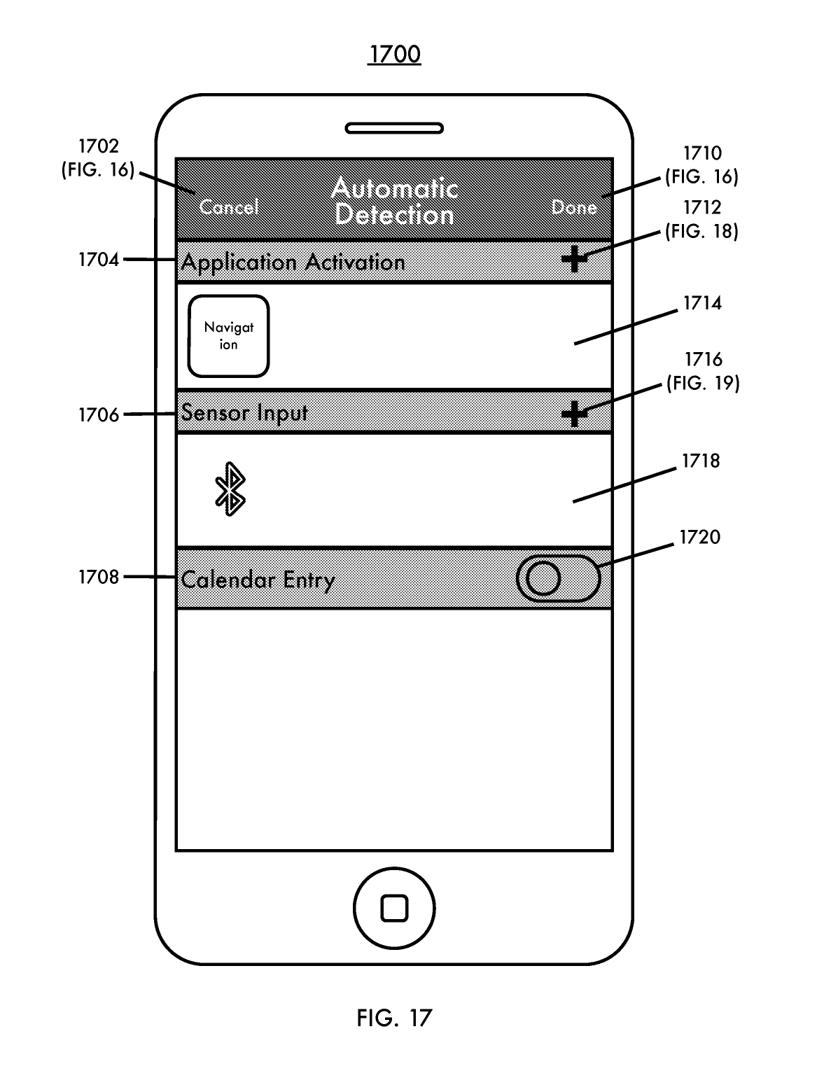

FIG. 15 to FIG. 25 shows screenshots of an embodiment to explain how activity-centric contextual mode of operation and criteria for automatic detection are defined as in step 1302 of FIG. 13. Touching “add new user-activity” button 1504 may segue to new user-activity editing screen 1600 of FIG. 16. New user-activity editing screen 1600 has user-activity name editing cell 1606, user-activity description editing cell 1608, “add new automatic detection criteria” button 1610, current automatic detection criteria cell 1612, “add new activity-centric contextual mode of operation” button 1614, and current activity-centric contextual mode of operation cell 1616. When editing cells 1606 and 1608 are touched, keyboards may pop up for text editing. Touching “cancel” button 1602 will take user back to the first screen 1500. When user is done editing a new user-activity, automatic detection criteria, and activity-centric contextual mode of operation, user may press “done” button 1604, which will save said new user-activity, automatic detection criteria, and activity-centric contextual mode of operation, and segue back to the first screen 1500.

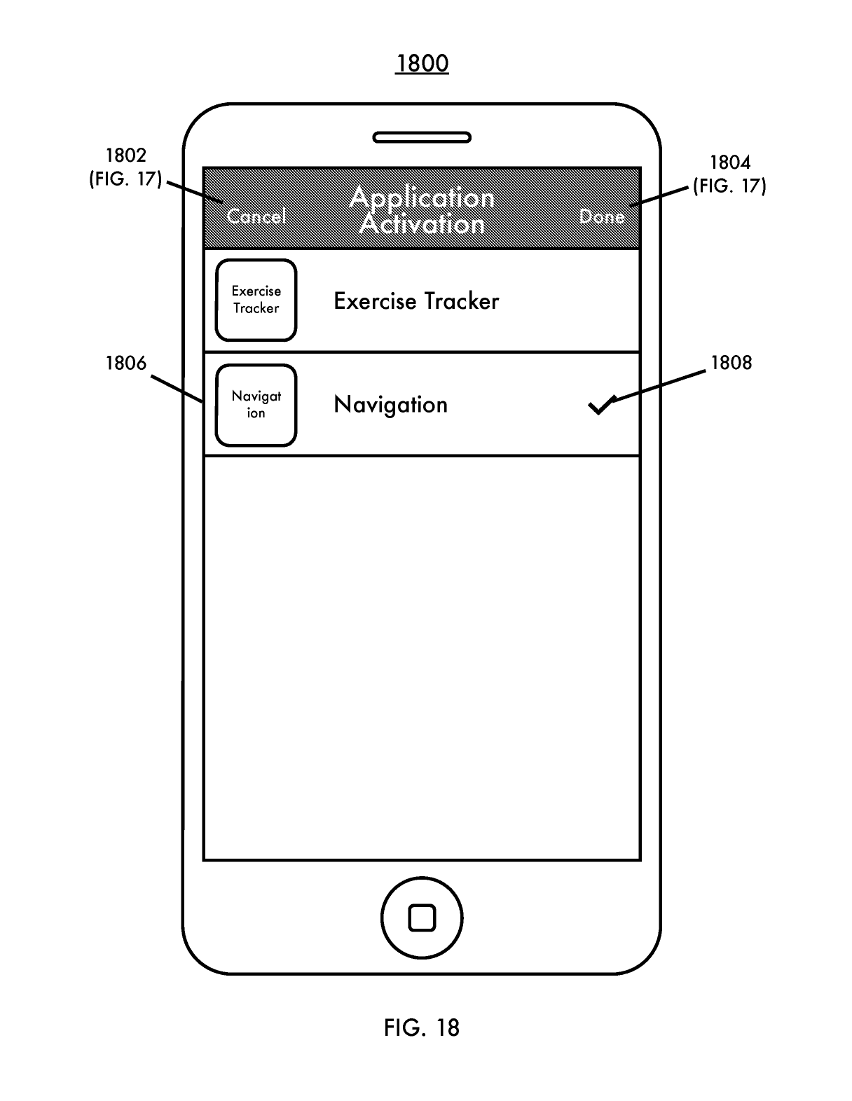

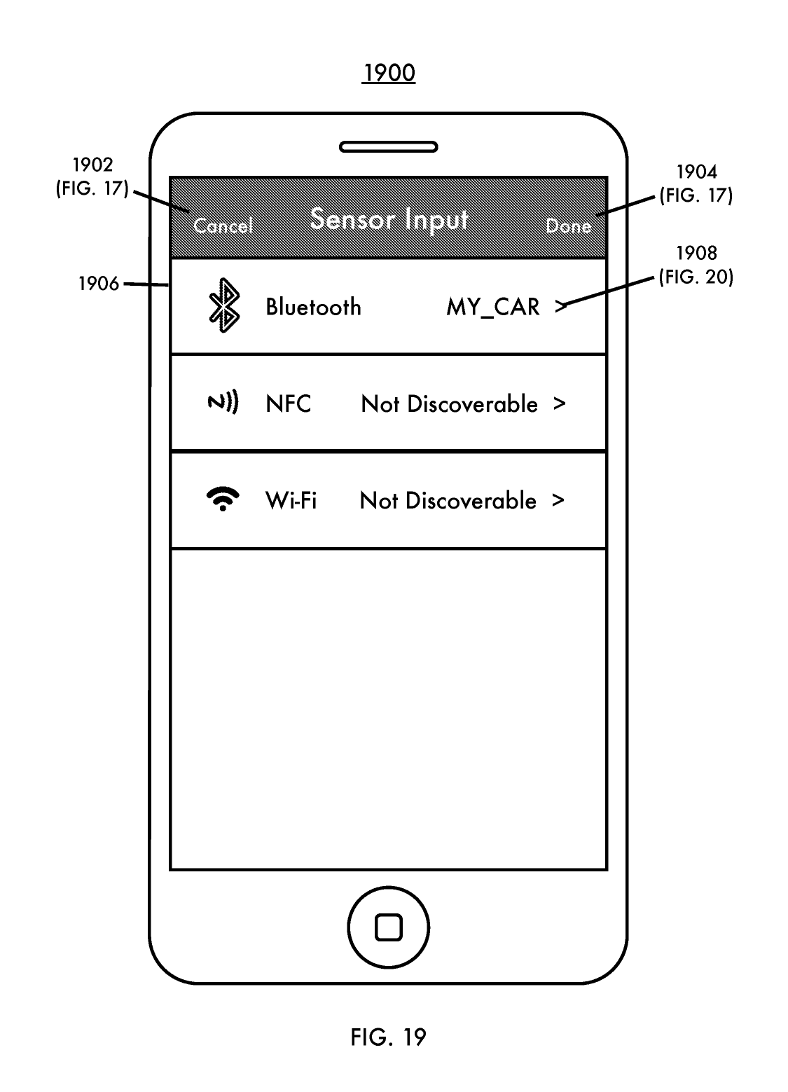

User may add new automatic detection criteria via “add new automatic detection criteria” button 1610, which may be used to define conditions where an embodiment of this invention may automatically detect a new user-activity as in step 1310 of FIG. 13. An illustrative screenshot of automatic detection editing screen 1700 of FIG. 17 shows examples of automatic detection criteria in this embodiment. This embodiment has three different ways of detecting a new user-activity automatically. This embodiment may auto-detect a new user-activity by pre-defined application activation 1704, pre-defined sensor input 1706, and/or pre-defined calendar entry 1708. In this example of screenshot 1700, activating navigation application or sensing a pre-defined Bluetooth as exemplified in cells 1714 and 1718 may automatically detect a new user-activity “Driving” as exemplified in cell 1606. Auto-detecting user-activity “Driving” via calendar entry is not allowed in this example as shown with disabled switch 1720. Touching “cancel” button 1702 will take user back to the new user-activity editing screen 1600 of FIG. 16. When user is done editing new automatic detection criteria, user may press “done” button 1710, which will save said new automatic detection criteria and segue back to the new user-activity editing screen 1600.

As shown in application activation cell 1714 as example, activating navigation application will trigger automatic detection of user-activity “driving”. User may add more applications to application activation cell 1714 through “add application activation” button 1712, which segue to an illustrative screenshot of application activation editing screen 1800 of FIG. 18 where user may select more applications. FIG. 18 shows how to add applications to automatic detection criteria. In this example, two available applications of exercise tracker and navigation are shown but navigation application cell 1806 is only selected as check marked with marker 1808. When selection is done, user may press “done” button 1804 to save the selection and segue back to screen 1700. When user wants to cancel any selection and segue back to screen 1700, user may press “cancel” button 1802.

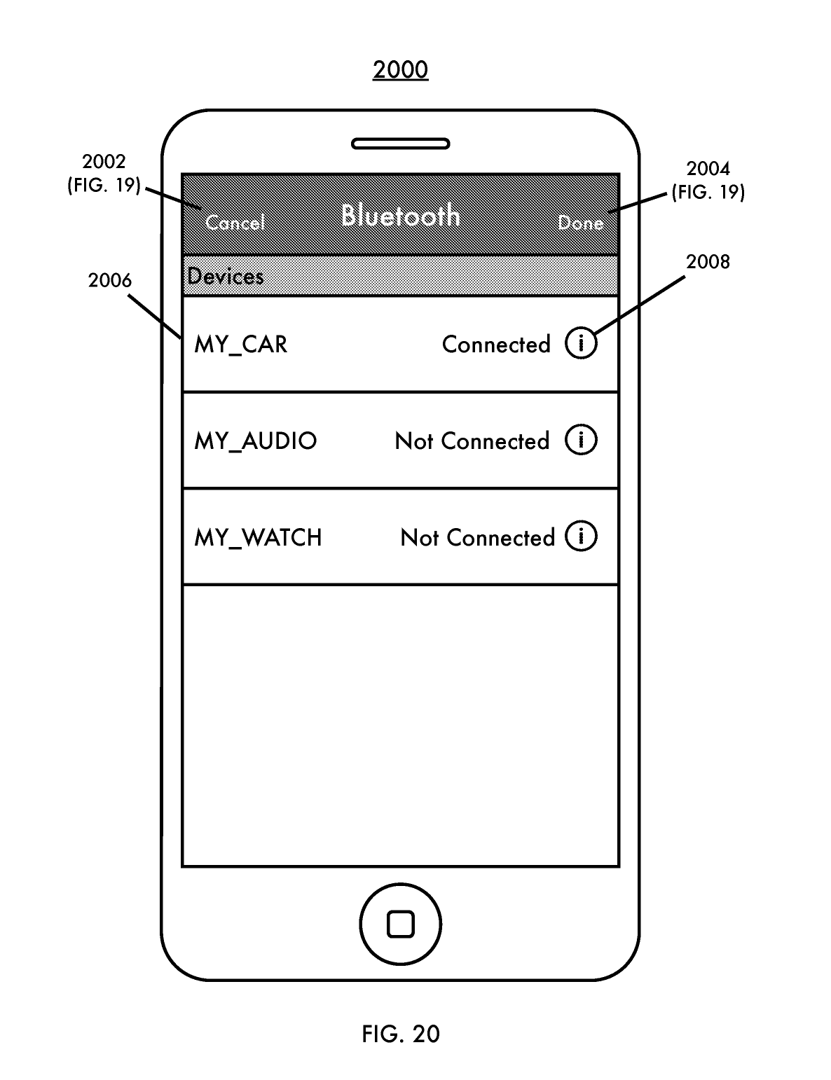

As shown in sensor input cell 1718 as example, predefined Bluetooth input will trigger automatic detection of user-activity “driving”. User may add sensor inputs to automatic detection criteria through “add sensor input” button 1716, which segue to an illustrative screenshot of sensor input editing screen 1900 of FIG. 19. FIG. 19 shows how to add sensor inputs to automatic detection criteria. In this example, cell 1906 shows that Bluetooth network “MY_CAR” of user's car is discovered and added to criteria. Arrow button 1908 may segue to an illustrative screenshot of Bluetooth input editing screen 2000 of FIG. 20 where discovered Bluetooth networks are displayed. In this example, user selects Bluetooth network “MY_CAR” as shown in cell 2006. Information button 2008 may provide detailed information about Bluetooth network of corresponding cell. When Bluetooth network selection is done for automatic detection criteria, user may press “done” button 2004 to save the selection and segue back to screen 1900. When user wants to cancel any selection and segue back to screen 1900, user may press “cancel” button 2002. Other sensor inputs, such as but not limited to NFC, QR code, Wi-Fi, Bluetooth, other tagging technologies, other network technologies, or combinations thereof, may also be used as automatic detection criteria. When selection is done for all sensor inputs, user may press “done” button 1904 to save the selection and segue back to screen 1700. When user wants to cancel any selection and segue back to screen 1700, user may press “cancel” button 1902.

Current activity-centric contextual mode of operation cell 1616 shows exemplary activity-centric contextual modes of operation for user-activity “driving”. Navigation application, primary device settings, and garage gate control are defined in the exemplary activity-centric contextual modes of operation for user-activity “driving”. Thus, when exemplary user-activity “driving” is detected, predefined changes to functionalities are applied to navigation application, primary device settings, and garage gate control automatically as shown in cell 1616.

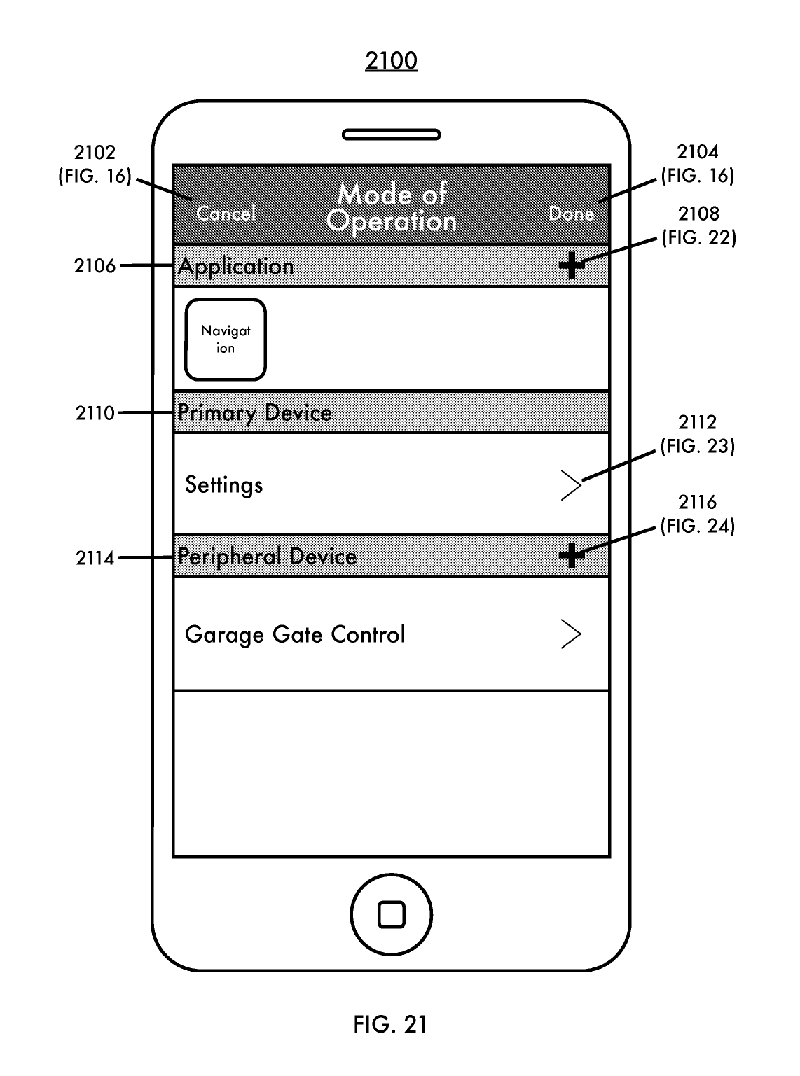

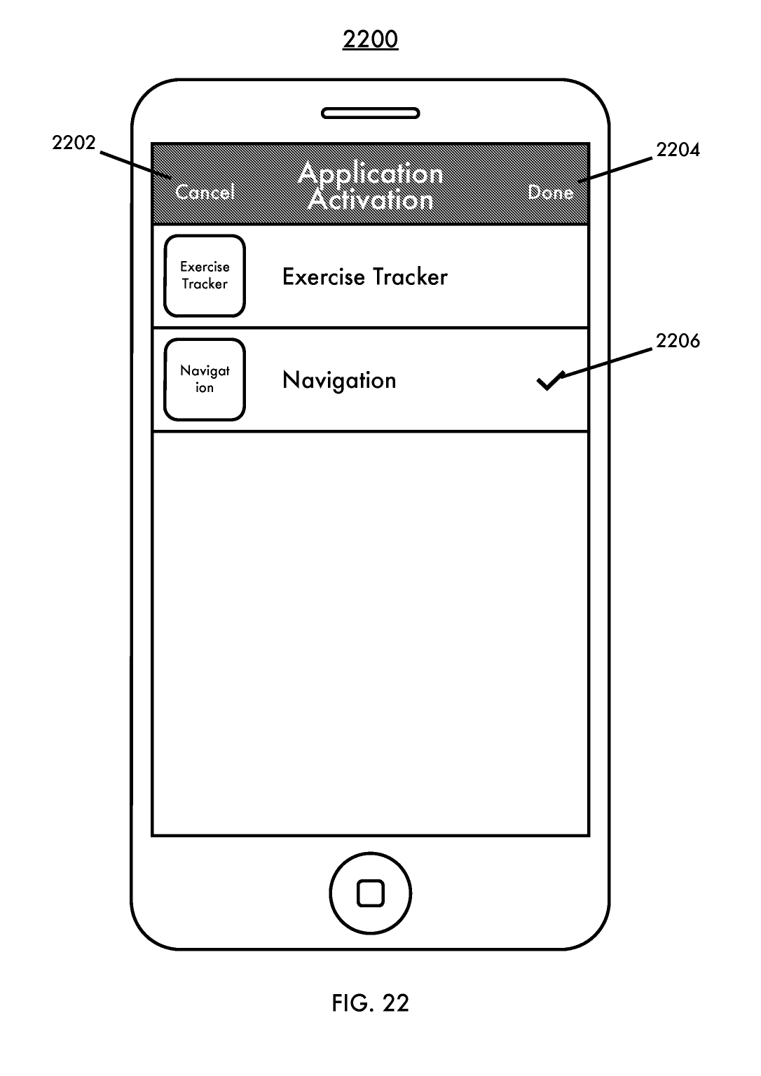

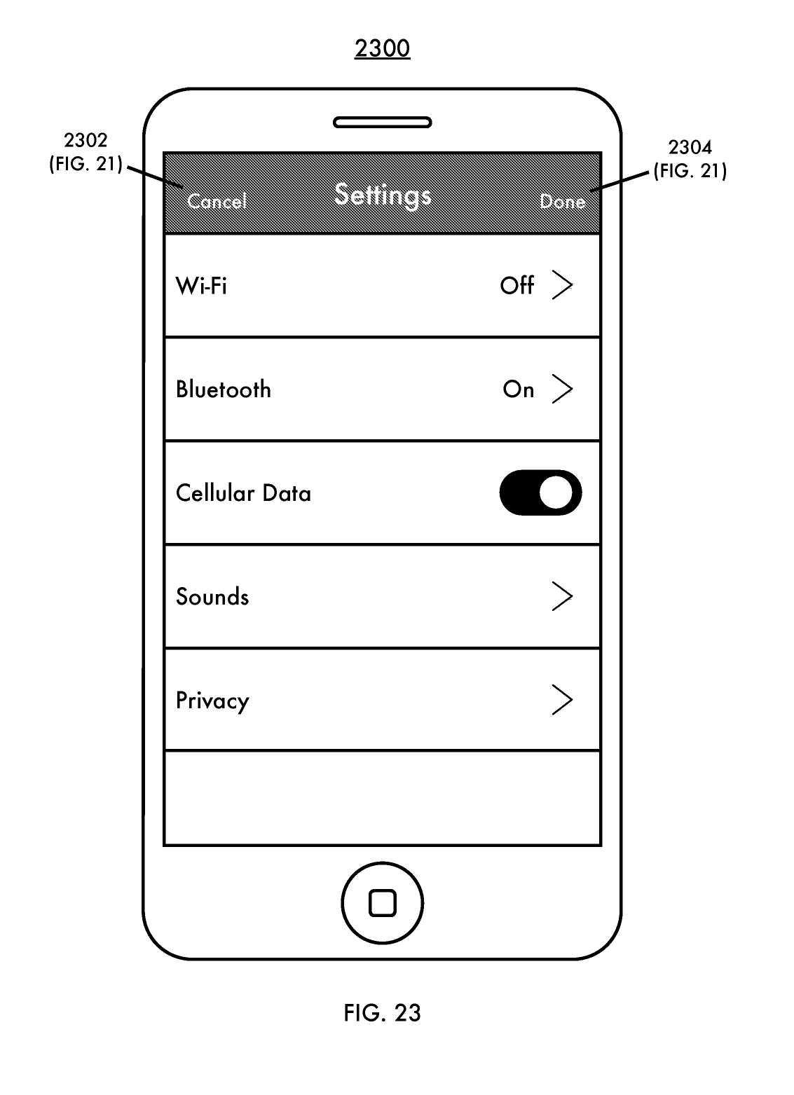

In order to edit activity-centric contextual modes of operation, user may use “add activity-centric contextual mode of operation” button 1614 of FIG. 16. “Add activity-centric contextual mode of operation” button may segue to an illustrative screenshot of activity-centric contextual mode of operation editing screen 2100 of FIG. 21 where user may edit and add activity-centric contextual modes of operation for corresponding user-activity. In the exemplary embodiment of smart phone, changes to functionalities of electronic devices may include applications to be automatically activated as shown in 2106, smart phone device setting to be changed as shown in 2110, and secondary/peripheral devices settings to be changed as shown in 2114.

In the example shown in screen 2100, navigation application is defined as one of activity-centric contextual modes of operation. Therefore, when user-activity “driving” is detected, navigation application is automatically activated. To add more applications to be activated for user-activity “driving”, “add application” button 2108 may be used. “Add application” button 2108 may segue to an illustrative screenshot of application activation editing screen 2200 of FIG. 22 where all available applications are displayed. In this example of FIG. 22, exercise tracker and navigation are the available applications and navigation application is selected as check marked with marker 2206. When selection is done, user may press “done” button 2204 to save the selection and segue back to screen 2100. When user wants to cancel any selection and segue back to screen 2100, user may press “cancel” button 2202.

Activity-centric contextual modes of operation may also define primary device settings as shown in 2110 so that when exemplary user-activity “driving” is detected, predefined primary device settings are applied. In the example, pressing arrow button 2112 may segue to an illustrative screenshot of primary device settings editing screen 2300 of FIG. 23 where user may change primary device settings in order to suit exemplary user-activity “driving”. As shown in screen 2300, primary device settings for activity-centric contextual modes of operation may include, but not limited to, Wi-Fi network, Bluetooth network, cellular data usage, device sound, and device privacy. When primary device settings are defined for activity-centric contextual mode of operation, user may press “done” button 2304 to save the selection and segue back to screen 2100. When user wants to cancel any selection and segue back to screen 2100, user may press “cancel” button 2302.

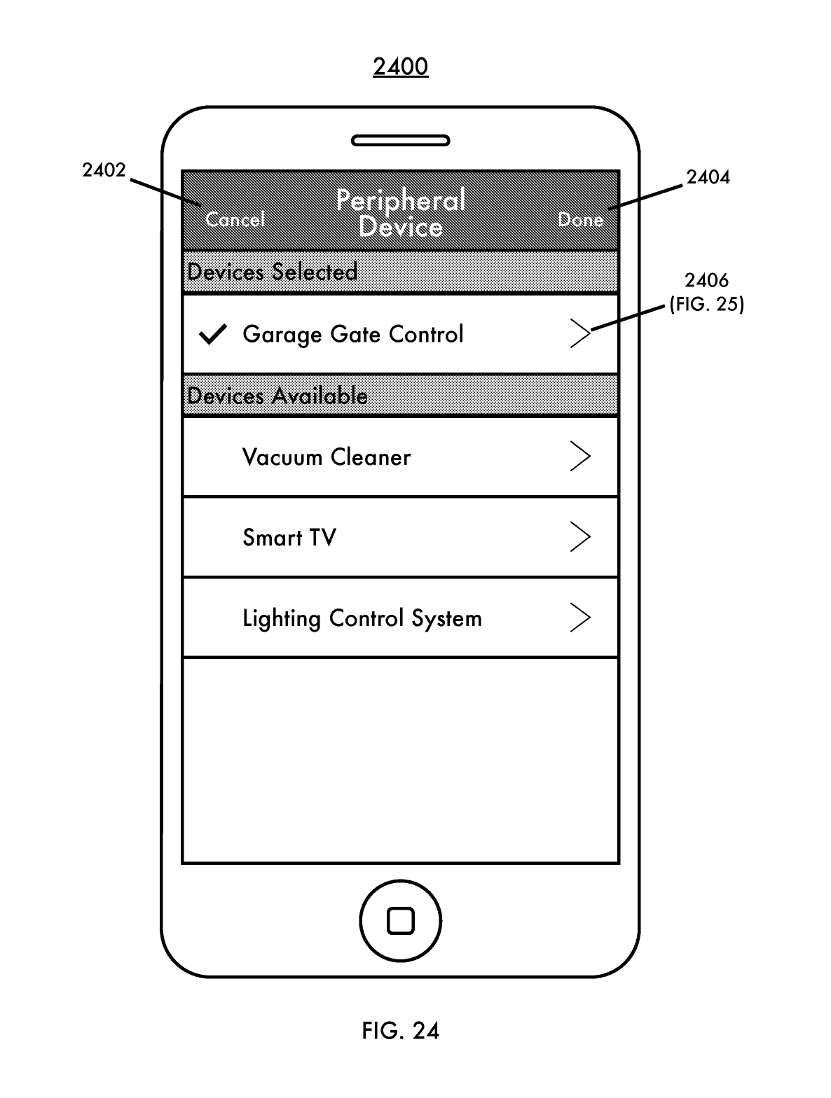

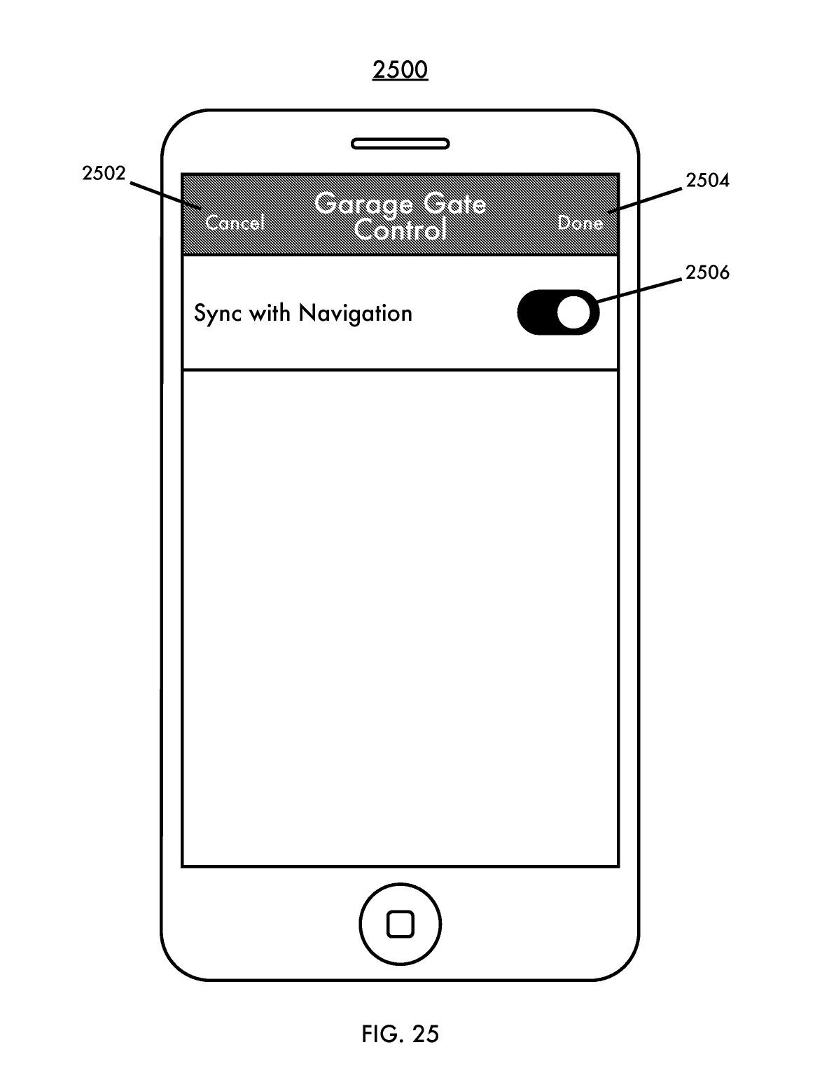

Activity-centric contextual modes of operation may also include secondary/peripheral devices so that when exemplary user-activity “driving” is detected, predefined settings are applied to secondary/peripheral devices. In the example of user-activity “driving”, garage gate control system is selected as a secondary/peripheral device to be activated when user-activity “driving” is detected as shown in FIG. 21. To define additional secondary/peripheral devices settings for user-activity “driving”, “add peripheral device” button 2116 of FIG. 21 may be used. “Add peripheral device” button 2116 may segue to an illustrative screenshot of peripheral device editing screen 2400 of FIG. 24 where user may edit and add secondary/peripheral device as activity-centric contextual modes of operation. In this example of FIG. 24, garage gate control system is selected as secondary/peripheral device to be added to activity-centric contextual modes of operation for “driving” activity. “Detail information” arrow 2406 may be used to access and edit settings for secondary/peripheral devices, garage control system in this example. “Detail information” arrow 2406 may segue to an illustrative screenshot of peripheral device settings editing screen 2500 of FIG. 25, where user may edit functions and settings of garage gate control system to suit user-activity “driving”. In the example, garage gate control system may synchronize with navigation app in user's primary device smart phone to open or shut garage gate. In the example, garage gate may open when navigation application is activated within user's home premise or when home as destination is reached. Screen 2400 may show other secondary/peripheral devices available in premise or within network (e.g., Wi-Fi, Bluetooth, NFC, etc), as shown with examples (vacuum cleaner, smart TV, and lighting control system) in FIG. 24.

FIG. 16 to FIG. 25 shows how activity-centric contextual modes of operation are defined as in step 1302 of FIG. 13. Once activity-centric contextual modes of operations are defined for corresponding user-activities, electronic device may be in stand-by mode as in step 1304 of FIG. 13, waiting to detect a new user-activity by user's manual input as in step 1308, by automatic detection as in step 1310, or by notification by other electronic devices as in step 1312.

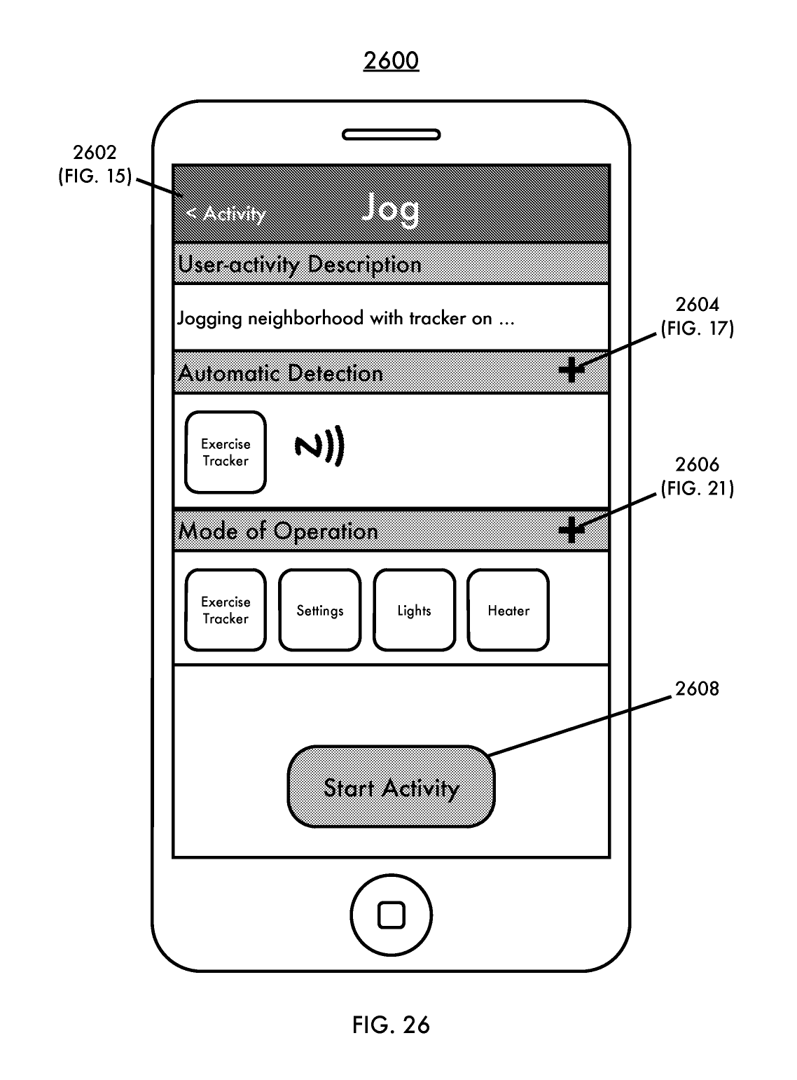

FIG. 26 shows how new user-activity is detected by user's manual input as in step 1308. User may press slider button 1506 from first screen 1500 of this invention to manually select a new user-activity, in this example user-activity “jog”, which segue to new user-activity start confirmation screen 2600 of FIG. 26. Screen 2600 of this invention assesses and displays pre-defined activity-centric contextual modes of operation and automatic detection criteria for user-activity “jog” as in step 1316. User may use button 2604 to make changes to automatic detection criteria and button 2606 to make changes to activity-centric contextual modes of operation. Button 2604 may segue to automatic detection editing screen, identical to screen 1700 of FIG. 17, and allow user to make changes to automatic detection criteria, following identical steps as in step 1302. Button 2606 may segue to activity-centric contextual mode of operation editing screen, identical to screen 2100 of FIG. 21, and allow user to make changes to activity-centric contextual modes of operation, following identical steps as in step 1302. When user has confirmed automatic detection criteria and activity-centric contextual modes of operation, user may press “start activity” button 2608 to confirm new user-activity as in step 1320 of FIG. 13B, or press “activity” button to cancel changes and segue back to first screen 1500 of FIG. 15.

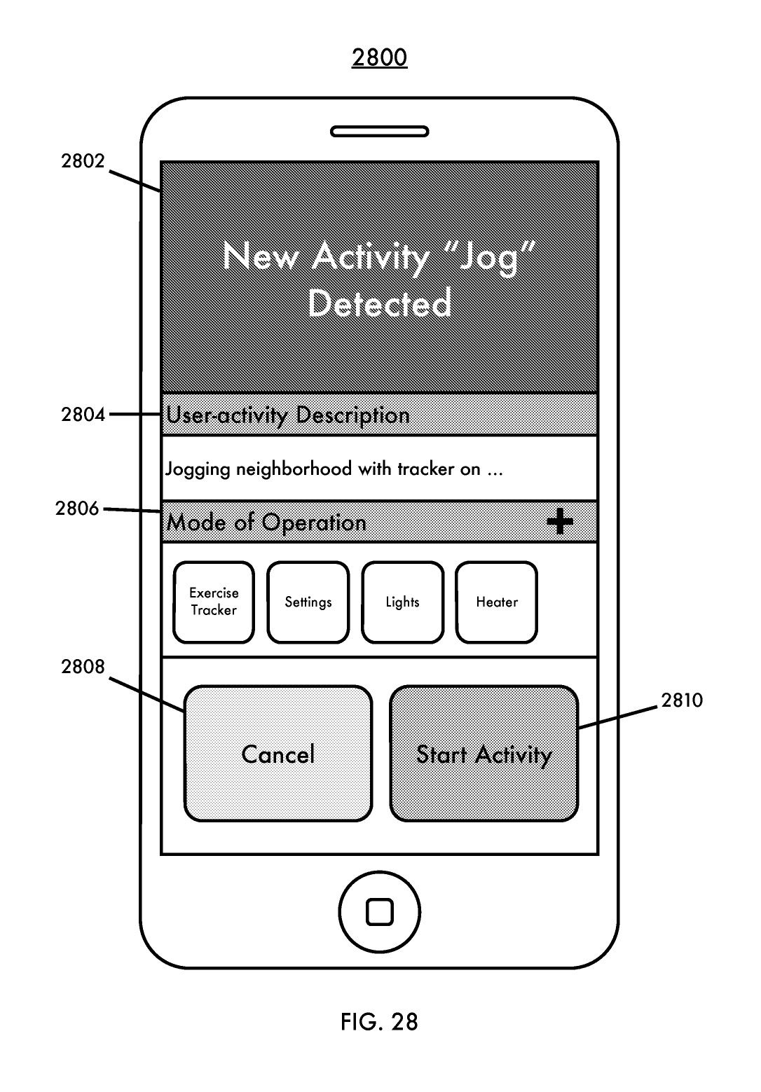

FIG. 28 shows an illustrative screenshot of new user-activity detection confirmation screen 2800. When pre-defined automatic detection criteria are met as in step 1310 of FIG. 13A, electronic device of this invention may display new user-activity detection confirmation screen 2800 of FIG. 28 as in step 1316. New user-activity detection confirmation screen 2800 shows new user-activity alert 2802, user-activity description 2804, activity-centric contextual mode of operation information 2806, cancel button 2808, and accept button 2810. User may ignore automatic detection alert and be sent back to previous screen by using cancel button 2808, or accept automatic detection alert and start detected user-activity by using accept button 2810 as in step 1320 of FIG. 13B.

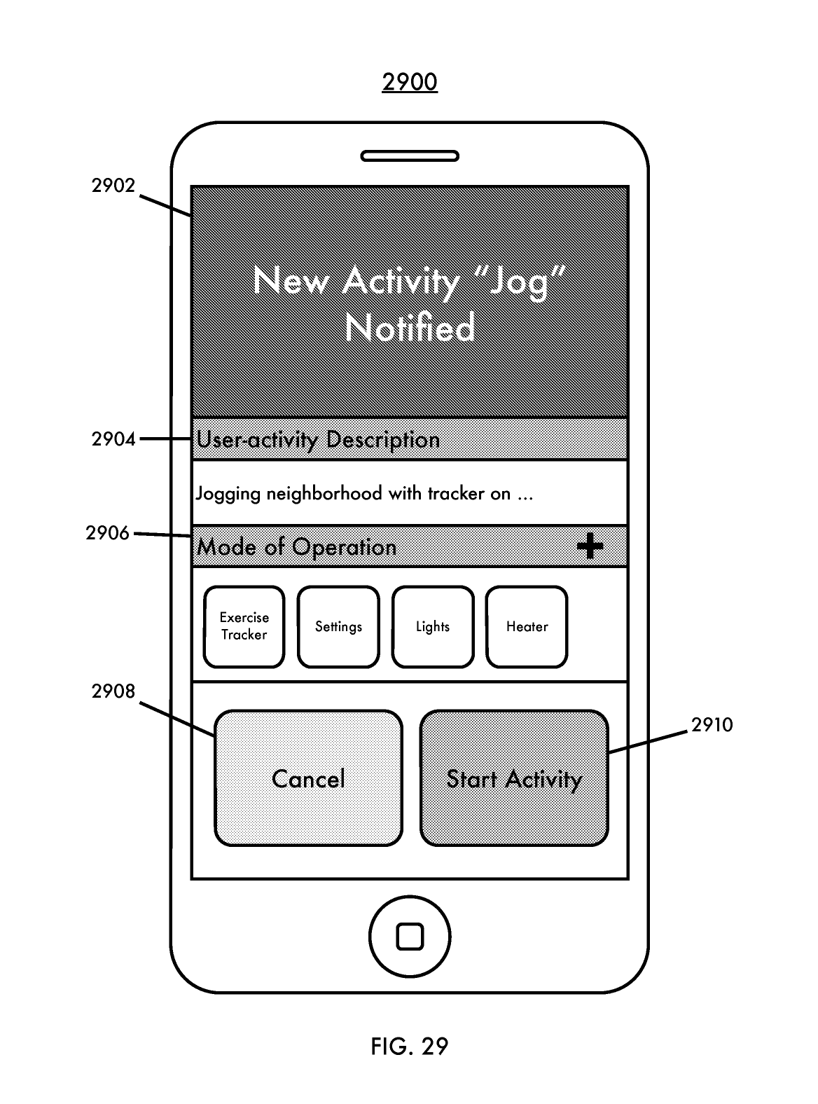

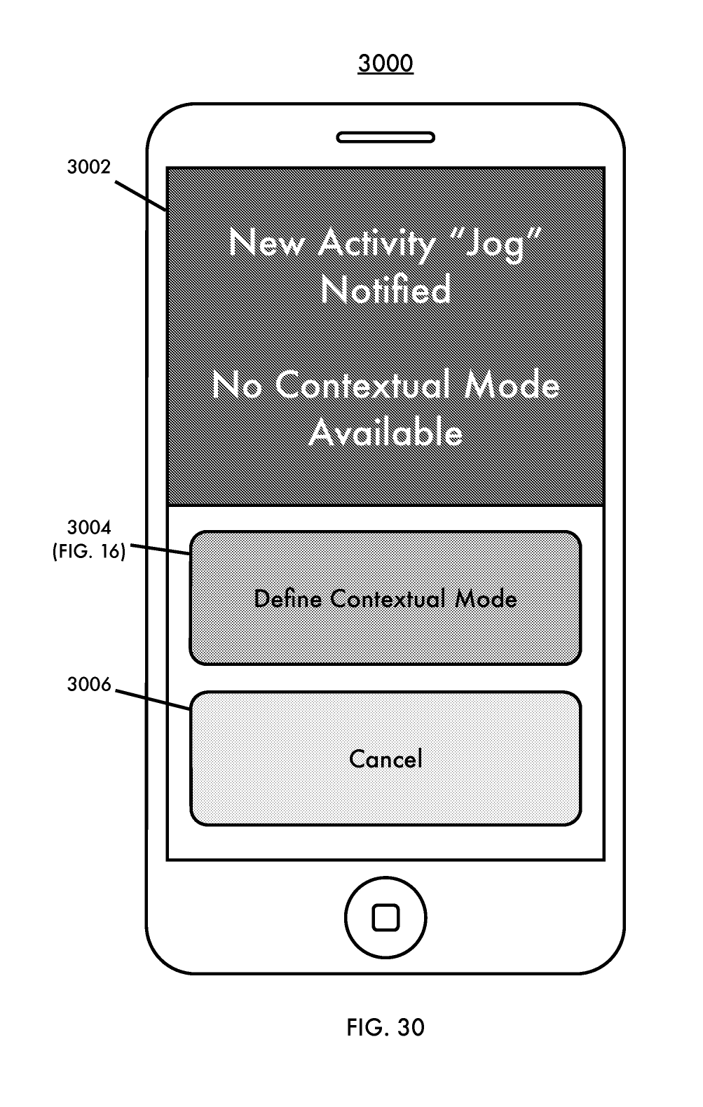

FIG. 29 and FIG. 20 show an illustrative screenshot of new user-activity notification confirmation screen and an illustrative screenshot of no contextual mode alert screen respectively. When secondary/peripheral electronic devices notify a new user-activity as in step 1312 of FIG. 13A, electronic device of this invention may display new user-activity notification confirmation screen 2900 of FIG. 29 if the notified user-activity exists in primary electronic device as in step 1316 or no contextual mode alert screen 3000 of FIG. 30 if the notified user-activity does not exist in primary electronic device as in step 1318.

If the notified user-activity exits in primary electronic device, primary electronic device may show new user-activity notification alert 2902, user-activity description 2904, activity-centric contextual mode of operation information 2906, cancel button 2908, and accept button 2910. User may ignore notification alert and be sent back to previous screen by using cancel button 2908, or accept notification alert and start notified user-activity by using accept button 2910 as in step 1320 of FIG. 13B.

If the notified user-activity does not exit in primary electronic device, primary electronic device may show new user-activity notification alert 3002 with message that there is no activity-centric contextual mode of operation available for the notified user-activity in the primary electronic device. Primary electronic device may also display contextual mode edit button 3004 and cancel button 3006. Contextual mode edit button 3004 may segue to new user-activity editing screen, identical to 1600 of FIG. 16 for new user-activity editing. User may ignore notification alert and press cancel button 3006 to be sent back to previous screen.

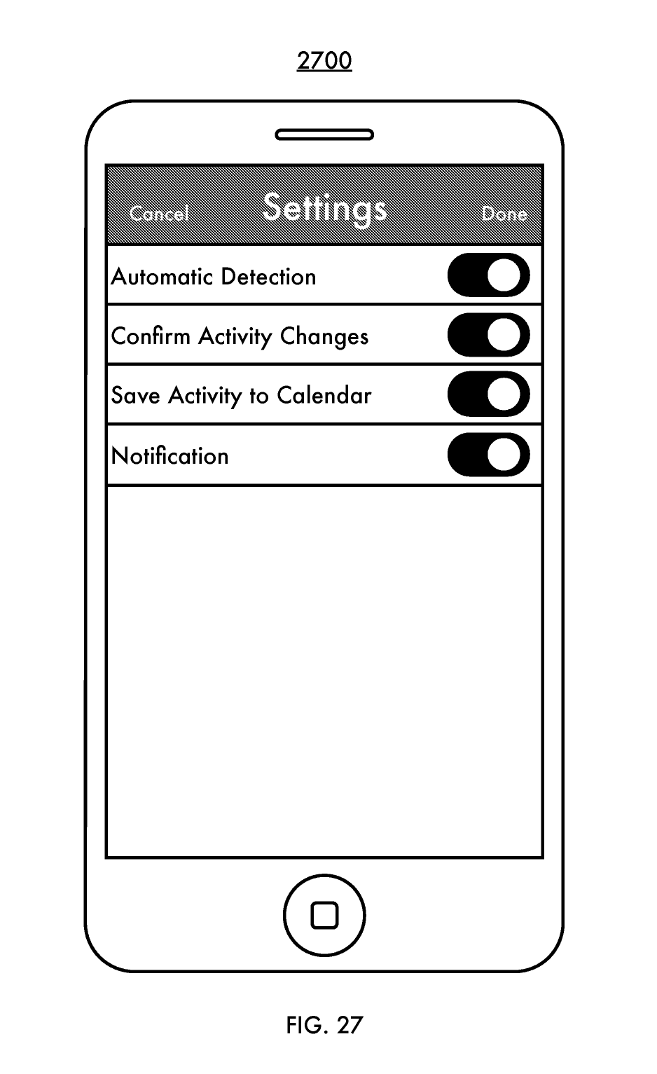

First screen 1500 of this invention may have settings button 1508 which may segue to illustrative settings editing screen 2700 of FIG. 27. As exemplary settings show in screen 2700, settings of this invention may include, but not limited to, automatic detection switch which able/disable automatic detection, user confirmation switch which able/disable user confirmation, calendar entry switch which able/disable user-activity to calendar entry, and notification switch which able/disable new user-activity notification from secondary/peripheral devices.

### CONCLUSION, RAMIFICATION, AND SCOPE

Electronic devices have become smarter and now use sensors to monitor environment in order to operate differently for different environmental conditions. This invention identifies user's activity and/or user's intention to an activity as the key environmental condition. Thus, electronic devices with this invention detect user's activity and/or user's intention to an activity, and operate differently for different user-activity and/or user's intention to different activity. User-activities are defined using the principle of 5W1H (When, Where, Who, What, Why, How) from linguistic grammar to describe full details of user-activity. For each user-activity, there are one or more respective activity-centric contextual modes of operation, which define how said electronic devices operate respectively and differently for different user-activities. This invention also provides how activity-centric contextual modes of operation should be implemented to plurality of electronic devices within network. Therefore, when one electronic device detects a new user-activity, said electronic device may notify said new user-activity to other electronic devices within network and plurality of electronic devices within network may shift to respective contextual modes of operation for said new user-activity.

Electronic devices are now flooding with functionalities. Complexity in functionality and thus difficulty in user experience weakens full potential of the electronic devices. For example, although smart phones have changed everyday lives of people with ever-extensive functionalities, many still struggle to exploit their mere potentials and even find more difficult to use than conventional flip phones. This invention defines systems and methods that simplify user interaction with electronic devices. Once activity-centric contextual modes of operation are defined for different user-activities, electronic devices of this invention may change their functionalities automatically when a new user-activity is detected. Therefore, user's interaction with said electronic devices may become as simple as selecting a new user-activity, or even simpler when the electronic devices detect a new user-activity automatically. As technologies, such as motion analysis and voice recognition, mature in future, home automation system of this invention may recognize user's intention for jogging by analyzing user's motion wearing running shoes and ask user “John, are you ready for jogging?” for confirmation and said user's mere interaction may become saying “yes” or “no” for the reply.

While detailed description of this invention contains embodiments with smart phone as the primary electronic device, these embodiments should not be construed as limitations on the scope, but rather as a typical exemplification of embodiments since smart phone stands for the major user interface device within current electronic devices. Thus, this invention may have embodiments with smart watch with voice recognition as the primary electronic device. In this case, user may “talk to” smart watch what his/her intention is for a new user-activity, and secondary/peripheral electronic devices of this invention will change functionalities to predefined activity-centric contextual modes of operation. Accordingly, the scope should be determined not by the embodiment(s) illustrated, but by the appended claims and their legal equivalents.

1. Methods for managing a plurality of contextual modes of operation in context of different user-activities associated with a plurality of electronic devices selected in the group consisting of but not limited to mobile devices, wearable devices, smart TVs, home appliances, home automation devices, building automation devices, automotive electronic devices, robots, and user interface devices, comprising:
A. determining user's activity or user's intention to an activity, either manually by means of said user's input through the input components of said electronic devices or automatically by means of activity detection,
and in response to the determined user-activity of said user from step A,
B. applying one or more respective modes of operation to at least one of said electronic devices, wherein a mode of operation comprises changing at least one of the functionalities of said electronic devices to predefined settings,
whereby changing the functionalities of said electronic devices in the context of said user's determined activity provide contextual, thereby substantially improved and simplified user experience of said electronic devices.

2. Methods of claim 1, further including, as for defining user's activity or user's intention to an activity, applying the principle of 5W1H (When, Where, Who, What, Why, How) from linguistic grammar and corresponding data structure to gather, store, and access information on user's activity.

3. Methods of claim 1, further including, as for determining user's activity or user's intention to an activity manually by means of said user's input through the input components of said electronic devices, applying means of said user's input through the input components of wearable electronic devices, such as but not limited to smart watches, smart necklaces, smart rings, smart bracelets, electronic devices as wearable accessories, electronic devices as wearable jewelry, or combinations thereof.

4. Methods of claim 1, further including, as for determining user's activity or user's intention to an activity automatically by means of activity detection, applying means of tagging for activity detection, such as but not limited to NFC, QR code, bar code, RFID, other tagging technologies, or combinations thereof.

5. Methods of claim 1, further including, as for determining user's activity or user's intention to an activity automatically by means of activity detection, applying means of interpreting said user's actions and behaviors, such as but not limited to voice recognition, motion/gesture recognition, brain-computer interface, other artificial intelligence technologies, or combinations thereof.

6. Methods of claim 1, further including, as for determining user's activity or user's intention to an activity automatically by means of activity detection, applying predefined criteria of the data, the input components, or the communication data of said electronic devices to monitor said criteria and automatically detect activity, and applying predefined data structure for editing, storing, sharing and/or accessing said predefined criteria to the data storage means of said electronic devices and network storage means.

7. Methods of claim 1, further including, as for said predefined settings, using predefined data structure for editing, storing, sharing and/or accessing functionality settings of said electronic devices to the data storage means of said electronic devices and network storage means.

8. Methods of claim 1, wherein the functionalities of said electronic devices may include but not limited to accessibility of input components, output components, communication module, storage, memory, media assets, and/or software components of said electronic devices.

9. Methods of claim 1, wherein said electronic devices are connected via network and the determined user's activity or user's intention to an activity and respective contextual modes of operation are communicated, edited, stored to and accessed over the network.

10. Methods of claim 1, further including, saving user's activity or user's intention to an activity as calendar entry to calendar function of said electronic devices.

11. Systems for managing a plurality of contextual modes of operation in context of different user-activities associated with a plurality of electronic devices selected in the group consisting of but not limited to mobile devices, wearable devices, smart TVs, home appliances, home automation devices, building automation devices, automotive electronic devices, robots, and user interface devices, comprising:
A. means of determining user's activity or user's intention to an activity, either manually by means of said user's input through the input components of said electronic devices or automatically by means of activity detection,
and in response to the determined user-activity of said user from step A,
B. means of applying one or more respective modes of operation to at least one of said electronic devices, wherein a mode of operation comprises changing at least one of the functionalities of said electronic devices to predefined settings,
whereby changing the functionalities of said electronic devices in the context of said user's determined activity provide contextual, thereby substantially improved and simplified user experience of said electronic devices.

12. Systems of claim 11, further including, as for defining user's activity or user's intention to an activity, means of applying the principle of 5W1H (When, Where, Who, What, Why, How) from linguistic grammar and corresponding data structure to gather, store, and access information on user's activity.

13. Systems of claim 11, further including, as for determining user's activity or user's intention to an activity manually by means of said user's input through the input components of said electronic devices, means of said user's input through the input components of wearable electronic devices, such as but not limited to smart watches, smart necklaces, smart rings, smart bracelets, electronic devices as wearable accessories, electronic devices as wearable jewelry, or combinations thereof.

14. Systems of claim 11, further including, as for determining user's activity or user's intention to an activity automatically by means of activity detection, means of tagging for activity detection, such as but not limited to NFC, QR code, bar code, RFID, other tagging technologies, or combinations thereof.

15. Systems of claim 11, further including, as for determining user's activity or user's intention to an activity automatically by means of activity detection, means of interpreting said user's actions and behaviors, such as but not limited to voice recognition, motion/gesture recognition, brain-computer interface, other artificial intelligence technologies, or combinations thereof.

16. Systems of claim 11, further including, as for determining user's activity or user's intention to an activity automatically by means of activity detection, means of applying predefined criteria of the data, the input components, or the communication data of said electronic devices to monitor said criteria and automatically detect activity, and means of applying predefined data structure for editing, storing, sharing and/or accessing said predefined criteria to the data storage means of said electronic devices and network storage means.

17. Systems of claim 11, further including, as for said predefined settings, means of using predefined data structure for editing, storing, sharing and/or accessing functionality settings of said electronic devices to the data storage means of said electronic devices and network storage means.

18. Systems of claim 11, wherein the functionalities of said electronic devices may include but not limited to accessibility of input components, output components, communication module, storage, memory, media assets, and/or software components of said electronic devices.

19. Systems of claim 11, wherein said electronic devices are connected via network and the determined user's activity or user's intention to an activity and respective contextual modes of operation are communicated, edited, stored to and accessed over the network.

20. Systems of claim 11, further including, means of saving user's activity or user's intention to an activity as calendar entry to calendar function of said electronic devices.
